(19) United States
(12) Patent Application Publication
(10) Pub. No.: US 2017/0102779 A1
(43) Pub. Date: Apr. 13, 2017

(54) DEVICE AND METHOD FOR INPUTTING CHINESE CHARACTERS, AND CHINESE CHARACTER SEARCH METHOD USING SAME

(71) Applicant: In Ki PARK, Busan (KR)

(72) Inventor: In Ki PARK, Busan (KR)

(21) Appl. No.: 15/128,828

(22) PCT Filed: Mar. 25, 2015
(86) PCT No.: PCT/KR2015/002931

§ 371 Date: Sep. 23, 2016

(30) Foreign Application Priority Data
Mar. 25, 2014 (KR) 10-2014-0034541

(51) Int. Cl. G06F 3/01; G06F 3/023; G06F 3/0482

(52) U.S. Cl. CPC G06F 3/018; G06F 3/0482; G06F 3/0237; G06F 3/0236; G06F 3/0238; G06F 17/2735

(57) ABSTRACT

A device for inputting Chinese characters according to the present invention is a Chinese character inputting device for inputting Chinese characters into an information communication terminal and comprises: character keys which use each stroke in [ [symbol] ] that are the components of the character system ‘ [symbol] ’ as basic graphemes, which consist of a plurality of keys for allocating graphemes formed through continuous transformation from the basic graphemes, and which are for inputting graphemes corresponding to the manipulation of one or a plurality of the keys in time series order; a selection key that enables the selection of one of the graphemes or Chinese characters that can be formed by manipulating the character keys; a storage unit that stores the graphemes, characters and Chinese characters formed of at least two or more graphemes that are coupled according to a set sequence; a control unit that searches the storage unit for graphemes inputted through the character keys, characters and Chinese characters formed through the coupling of at least two or more graphemes, and Chinese characters selected through the selection key, and generates the searched graphemes, characters, and Chinese characters; and a display unit on which the graphemes inputted through the character keys, the characters or the Chinese characters selected through the selection key, and the graphemes, the characters, and the Chinese characters generated by the control unit are displayed.

### TECHNICAL FIELD

The present invention relates to a device and method for inputting Chinese characters and a Chinese character search method using the same, and more particularly, to a device and method for inputting Chinese characters which take four graphemes in the smallest stroke unit in stroke order of the “ [symbol] ([mok], wood)” character system as basic graphemes representing character key groups and allow a Chinese character to be input and searched for through a combination of consecutive character keys starting with one of the basic graphemes, and a Chinese character search method using the same.

### BACKGROUND ART

It is not easy to input Chinese characters through IT devices such as computers or portable terminals.

For Korean and English, consonants and vowels are established as alphabetical components, and therefore consonants and vowels may be allocated to a keyboard or keypad such that the consonants and vowels can be input through IT devices.

However, it is difficult to input Chinese characters by marking Chinese characters directly on a keyboard or keypad. This is because Chinese characters are ideograms and are not configured according to a specific rule by nature. Further, there are incredibly many Chinese characters.

In particular, Chinese characters have a large number of radicals as components thereof. Further, most Chinese characters are combinations of radicals, but the combinations do not have structural regularity. Accordingly, it is difficult to technically process Chinese characters such that the Chinese characters are input according to a certain rule.

China, Taiwan, Japan and Korea employ English alphabet, Bopomofo, Kana characters, and Hangul, respectively as auxiliary means for searching for and inputting Chinese characters.

These auxiliary means rely on pronunciation in common.

Among the conventional Chinese character input methods is a stroke input method of inputting components of a Chinese character by dividing the components into five strokes “ [symbol] ,” “ [symbol] ,” “ [symbol] ,” “ [symbol] ,” and “ [symbol] .” In the method, the shapes of the five strokes “ [symbol] ,” “ [symbol] ,” “ [symbol] ,” “ [symbol] ,” and “ [symbol] ” are marked on keys, and a Chinese character is input when keys corresponding to the respective strokes of the Chinese character are pressed in stroke order of the Chinese character. For example, to input “ [symbol] ,” the user needs to sequentially press keys corresponding to “ [symbol] ,” “ [symbol] ,” “ [symbol] ” and “ [symbol] ” which constitute “ [symbol] ” and then a specific key.

However, with this method of inputting Chinese characters, only a stroke input in the corresponding input step is displayed, which causes inconvenience because the user needs to continuously check if correct strokes are input for the Chinese character (namely, it is difficult to check whether there is a missing stroke and whether a stroke is normally input).

As another example, when English letters representing pronunciation of a Chinese character are input, several Chinese characters corresponding to the pronunciation are listed, and the intended character is input by pressing a specific key for the intended character (e.g., a number key indicating the sequential position of the character).

For example, when English letters “wo” representing pronunciation of “ [symbol] ” are input, multiple Chinese characters including “ [symbol] ” corresponding to the pronunciation of “wo” are displayed, and “ [symbol] ” is selected and input.

However, this method requires the user to be aware of English pronunciation of a Chinese character that the user intends to input and also requires all English letters to be marked on the keyboard or keypad. In addition, with this method, the user needs to input English letters corresponding to the Chinese character rather than directly inputting the Chinese character. Accordingly, this method requires many key inputs, and thus has a limit in increasing the input speed.

Meanwhile, various Chinese character search methods have been introduced for IT devices.

For example, search by total strokes is a method of searching for a Chinese character using the total strokes of the Chinese character.

This method requires the user to be aware of the number of strokes and variation of character shapes, which is challengeable.

For example, radicals “ [symbol] ” and “ [symbol] ” are defined as having 3 strokes and 4 strokes in the table of 214 radicals for traditional Chinese characters, while being defined as having 2 strokes and 3 strokes in the table of 200 radicals for simplified Chinese characters. To search for a Chinese character having both radicals “ [symbol] ” and “ [symbol] ” among simplified Chinese characters, the total strokes of the character calculated in the traditional Chinese character system should be reduced by one stroke. Search by total strokes provides very low search convenience as it takes some time to calculate the total strokes of an intended character.

The search methods also include search by radicals and search by pronunciation (pinyin pronunciation, Bopomofo pronunciation, pronunciation for meaning, or pronunciation of reading sound). Typically, Chinese character dictionaries and Chinese dictionaries are based on search by radicals. The method of search by radicals includes 1) calculating the number of total strokes of a radical, 2) checking the radical table for the page having the radical, and 3) finding the intended Chinese character by calculating the number of the strokes of the character except the radical. This procedure provides very low user convenience. For example, to search for “ [symbol] ([ga], a home)”, “ [symbol] ([mj [symbol] n], a roof),” which consists of three strokes, should be found in the radical table first, and then “ [symbol] ([si], a pig),” which consists of 7 strokes and constitutes the remaining part of “ [symbol] ,” should be searched for. For this reason, search by radicals has low efficiency.

Further, a character may be assigned different radicals. For example, the traditional Chinese character “ [symbol] ([si], to see)” belongs to the radical “ [symbol] ([gj [symbol] n], to see)”, while the simplified Chinese character “ [symbol] ([si], to see)” belongs to the radical “ [symbol] ([si], to show)”. As another example, the traditional Chinese character “ [symbol] ([gun], military)” belongs to the radical “ [symbol] ([g [symbol] ], a rickshaw)”, while the simplified Chinese character “ [symbol] ([gun], military)” belongs to the radical “ [symbol] ([mj [symbol] k], to cover).” It is difficult for users to use the search-by-radical method in various kinds of books as the number of radicals has significantly changed over time.

For example, Shuowenjiezi has 540 radicals, and the unabridged Chinese dictionary and unabridged Chinese character dictionary have 200 radicals, while Cihai (“ [symbol] ”) has 250 radicals. The dictionary Dai Kan-Wa jiten published in Japan and Chinese dictionaries published in Korea maintain a 214-radical system.

Unicode has 75,753 registered Chinese characters including 1) 20,902 characters of Chinese, Japanese, and Korean (CJK) Unified Ideographs, 2) 6,582 characters of CJK Unified Ideographs Extension-A, 3) 42,711 characters of CJK Unified Ideographs Extension-B, 4) 4,220 characters of CJK Unified Ideographs Extension-C, 5) 467 characters of CJK Compatibility Ideographs, 5) 214 radicals of Kangxi dictionary, 6) 115 characters of CJK Radicals Supplement, and 7) 542 characters of CJK Compatibility Ideographs Supplement. Because the exact number of Chinese characters is not known, and a table of 214 radicals is not present, it is difficult to intuitively search for Chinese characters. Further, even if the user is aware of the radical of a character, the user needs to check the strokes of the character one by one if the user does not know the group to which the extended Chinese character belongs.

With the method of search by pronunciation (pinyin pronunciation, Bopomofo pronunciation, pronunciation of a word indicating the meaning of a character, or pronunciation of the character), individual Chinese characters may be quickly searched for once pronunciations thereof are acquired. However, this method is disadvantageous in that it takes a long time to acquire pronunciations. Typically, since it is difficult for users to actually memorize all pronunciations (pinyin pronunciation, Bopomofo pronunciation, pronunciation of a word indicating the meaning of a character, or pronunciation of the character) of Chinese characters, a majority of Chinese character dictionaries and Chinese dictionaries are based on the method of search by radicals and have a pronunciation search list and a total-stroke search list.

For example, to enhance search convenience, Chinese dictionaries employ four tones chū, chú, ch\check{u}, and chù, which are four pronunciations of “chu,” as auxiliary means.

For pinyin, which is one of input pronunciations (pinyin pronunciation, Bopomofo pronunciation, pronunciation of a word indicating the meaning of a character, or pronunciation of the character), IT devices used in China adopt arrangement in order of frequency to improve efficiency of input.

The greatest reason for degradation of input efficiency of the search-by-pronunciation method is that only one direction key is used to find other Chinese characters.

For arrangement in order of frequency, multiple direction keys cannot be configured.

In performing search by pinyin in an unabridged Chinese character dictionary and unabridged Chinese dictionary, the search operation may be slowed if the user does not know the exact tone of a Chinese character among the four tones. Since arrangement of pinyin inputs in order of frequency does not coincide with pinyin arrangement in the Chinese character dictionary and Chinese dictionary, users may experience inconvenience in inputting characters. The same problem is raised in performing the search operation in dictionaries from Taiwan and Japan.

In this regard, Korean Patent Nos. 10-0643856, 10-0662553 and 10-0757372 of the applicant of this application disclose an input method using a mobile phone, an input method using a computer, and a method for handling a Chinese character database. These methods are based on alphabetical arrangement of Chinese characters.

According to the aforementioned patent documents of the applicant, the key concept of the alphabetical arrangement of Chinese characters is arrangement of strokes, and accordingly, there are insufficient reasons for considering that the Chinese character system is similar to the phonogram system.

This is because the smallest phonetic unit in the phonogram system is a grapheme.

In addition, although a Chinese character can have up to 46 strokes, alphabetical arrangement of a Chinese character limits the number of strokes to 28. Further, the method of alphabetical arrangement of Chinese characters lacks an arrangement principle, and accordingly there is confusion in arranging 28 strokes. Accordingly, alphabetical arrangement of Chinese characters is not related to the principle of character creation. None of the aforementioned patent documents of the applicant suggests how to use direction keys for Chinese characters to quickly input Chinese characters. Accordingly, the aforementioned patent documents provide low search and input efficiency. In addition, none of the aforementioned patent documents addresses the problem with arrangement in order of frequency which is adopted in the conventional method for inputting Chinese characters. Further, Korean Patent No. 10-0757372 of the applicant of this application discloses inputting a Chinese character in a window for a list of Chinese characters through meaningless numbers which have no relation to horizontal and vertical search, and limits an input means for search to a mouse.

### DISCLOSURE

### Technical Problem

An object of the present invention devised to solve the problem lies in a device and method for inputting Chinese characters which take four graphemes in stroke order in the “ [symbol] ([mok], wood)” character system as basic graphemes, classify graphemes which are consecutive variations of a basic grapheme into a character key group based on the basic graphemes, and cause a Chinese character to be input and searched for through a combination of character keys including the basic character graphemes, and a Chinese character search method using the same.

### Technical Solution

In accordance with an aspect of the present invention, the above and other objects can be accomplished by the provision of:

a device for inputting Chinese characters to an information technology terminal, including a character key including a plurality of keys assigned graphemes configured as consecutive variants from basic graphemes configured by strokes “ [symbol] ,” “ [symbol] ,” “ [symbol] ” and “ [symbol] ” in a stroke order system based on a “ [symbol] ” character system, the character key being configured to input the graphemes in a time series through one or more manipulations of the keys, a selection key configured to select one from among graphemes or Chinese characters configurable through manipulation of the character key, a storage unit configured to store the graphemes, characters and Chinese characters, the characters and Chinese characters being formed by combining, in a predetermined order, at least two graphemes selected from among the graphemes, a controller configured to perform a control operation to generate a characters and Chinese character formed by combining the at least two graphemes selected from among the graphemes, a Chinese character selected through the selection key, and a Chinese character input through the character key by searching the storage unit for the same, and a display unit configured to display the grapheme input through the character key, the character or Chinese character selected through the selection key, and the grapheme, character and Chinese character generated by the controller.

The graphemes comprise 28 graphemes divided into a first grapheme group represented by “ [symbol] ” among the basic graphemes and comprising “ [symbol] ,” “ [symbol] ,”, “ [symbol] ,” “ [symbol] ,” “ [symbol] ,” “ [symbol] ,” “ [symbol] ,” “ [symbol] ,” “ [symbol] , ” “ [symbol] ,” “ [symbol] ,” and “ [symbol] ,” having strokes starting to be written in the same direction, a second grapheme group represented by “ [symbol] ” and comprising “ [symbol] ,” “ [symbol] ,” “ [symbol] ,” “ [symbol] ,” “ [symbol] ,” and “ [symbol] ” having strokes starting to be written in the same direction, a third grapheme group represented by “ [symbol] ” and comprising “ [symbol] ,” [symbol] ,” [symbol] ,” [symbol] ,” [symbol] ,” and “ [symbol] ” having strokes starting to be written in the same direction, and a fourth grapheme group represented by “ [symbol] ” and including “ [symbol] ,” “ [symbol] ,” “ [symbol] ,” and “ [symbol] ” having strokes starting to be written in the same direction, wherein the 28 graphemes divided into the first to fourth grapheme groups are allocated to the keys of the character key, respectively.

Among the grapheme groups represented by the basic graphemes “ [symbol] ,” “ [symbol] ,” “ [symbol] ,” and “ [symbol] , ” the first grapheme group may be extended to include a first extended grapheme group having “ [symbol] ,” “ [symbol] ,” “ [symbol] ,” “ [symbol] ,” “ [symbol] ” and “ [symbol] ,” the second grapheme group may be extended to include a second extended grapheme group having “ [symbol] ,” “ [symbol] ,” “ [symbol] ,” “ [symbol] ,” and “ [symbol] ,” the third grapheme group may be extended to include a third extended grapheme group having “ [symbol] ,” “ [symbol] ,” “ [symbol] ,” and “ [symbol] ,” and the fourth grapheme group may be extended to include a fourth extended grapheme group having “ [symbol] ,” “ [symbol] ,” and “ [symbol] ,” wherein the graphemes of the first to fourth extended grapheme groups may be allocated to the keys of the character key, respectively, such that each of the graphemes of the extended grapheme groups are input through a plurality of manipulations of the character key.

Preferably, all the graphemes including the basic graphemes and the graphemes of the first to fourth extended grapheme groups may be distinguished from each other by principles of slant, length, stroke addition and protrusion of the basic graphemes “ [symbol] ,” “ [symbol] ,” “ [symbol] ,” and “ [symbol] ,” and may be input in order of manipulations of the character key assigned therewith.

Preferably, the device further includes at least one direction key, wherein, when not all Chinese characters can be displayed on the display unit, the controller performs a control operation to display hidden Chinese characters according to an input of the direction key. Preferably, the direction key is allocated to a Chinese character displayed on the display unit.

In addition, the remaining Chinese characters displayed according to the input through the direction key may include a plurality of Chinese characters having the Chinese character allocated to the direction key as a first Chinese character.

Preferably, at least one of the Chinese characters displayed on the display unit is assigned a shortcut key, wherein, when the shortcut key is selected, a plurality of Chinese characters starting with the Chinese character corresponding to the shortcut key is displayed on the display unit, and the controller performs a control operation to generate a Chinese character selected through the selection key among the plurality of displayed Chinese characters. In particular, the Chinese character assigned the shortcut key is preferably displayed so as to be distinguished from the other displayed Chinese characters.

Preferably, when a plurality of graphemes is sequentially input through the character key, the display unit displays a combinatorial character corresponding to a combination of the graphemes in each input step of the graphemes.

In accordance with another aspect of the present invention, there is provided a method for inputting Chinese characters to an information technology (IT) terminal, the method:

including providing the device for inputting Chinese characters and sequentially inputting graphemes of an intended Chinese character in stroke order of the Chinese character using the character key, displaying, on the display unit, a character formed by combining input graphemes of the graphemes every time a grapheme of the graphemes is sequentially input through manipulation of the character key, displaying, on the display unit, one or more Chinese characters including a character formed by combining the graphemes in a predetermined order, selecting the intended Chinese character from the displayed Chinese characters, and generating the selected Chinese character and inputting the same to the IT terminal.

Preferably, the displaying of the character formed by combining the input graphemes includes every time a grapheme of the Chinese character to be input are input in stroke order thereof, displaying, on the display unit, a new character formed by combining the grapheme with previously input graphemes of the Chinese character.

Preferably, the method further includes allocating a shortcut key to a specific Chinese character of the one or more Chinese characters displayed on the display unit, selecting the allocated shortcut key in inputting Chinese character, and displaying, on the display unit, at least one Chinese character started with the specific Chinese character corresponding to the selected shortcut key, wherein the allocating of the shortcut key, the selecting of the allocated shortcut key and the displaying of the at least one Chinese character are performed after the displaying of the one or more Chinese characters.

Preferably, when not all the Chinese characters can be displayed on the display unit, remaining hidden Chinese characters are additionally displayed according to an input of the direction key.

In accordance with another aspect of the present invention, there is provided a method for searching for Chinese characters using a device for inputting Chinese characters to an information technology (IT) terminal, the method including providing the device and a search key, sequentially inputting graphemes of an intended Chinese character in stroke order of the Chinese character using the character key, displaying, on the display unit, a character formed by combining input graphemes of the graphemes every time a grapheme of the graphemes is sequentially input through manipulation of the character key, displaying, on the display unit, one or more Chinese characters including a character formed by combining the graphemes in a predetermined order, selecting the intended Chinese character from the displayed Chinese characters, and searching for detailed information about the selected Chinese character stored in the storage unit according to an input of the search key and displaying the same on the display unit.

Preferably, the displaying of the one or more Chinese characters includes inputting the direction key when not all the Chinese characters including the character formed by combining the graphemes can be displayed on the display unit, and displaying remaining hidden Chinese characters according to the input of the direction key.

Preferably, the remaining Chinese characters displayed according to the input of the direction key include a plurality of Chinese characters starting with a Chinese character allocated to the direction key.

Preferably, a shortcut key is set to a specific Chinese character among the Chinese characters displayed on the display unit, wherein, when the shortcut key is selected, one or more Chinese characters starting with the Chinese character corresponding to the shortcut key are displayed on the display unit.

### Advantageous Effects

According to embodiments of the present invention, a device and method for inputting Chinese characters using the “ [symbol] ” character system and a Chinese character search method using the same have the following effects.

First, when the Chinese character list of Unicode arranged based on 214 radicals is applied to the “ [symbol] ” character system, characters may be intuitively searched for and input as in the case of an English dictionary. In addition, the same effect may be achieved for all other Chinese character dictionaries and Chinese dictionaries.

Second, when the Unicode Chinese character list is applied to the “ [symbol] ” character system for search by pronunciation (pinyin pronunciation, Bopomofo pronunciation, pronunciation of a word indicating the meaning of a character, or pronunciation of the character), search by total strokes, search by strokes, and search by writing, characters may be intuitively searched for and input.

Third, while the conventional radical input method requires a radical table as an auxiliary means, application of the “ [symbol] ” character system eliminates the need for a radical table.

Fourth, the pinyin input method and the total stroke input method require four tones and five strokes as auxiliary means when there are many Chinese characters. On the other hand, the method of the present invention does not require an auxiliary means regardless of the number of Chinese characters.

Fifth, with the list of all Chinese characters including about 70,000 Unicode characters, characters may be intuitively searched for and input using mobile means such as a mouse, a touch pen, a stylus pen, laser and pupils.

Sixth, by applying the concept of phonograms to ideograms, burdens to users may be greatly reduced compared to the conventional input methods because character arrangement for search is identical to character arrangement for the input operation.

Seventh, a character may be independently input without an auxiliary means such as a keyboard or keypad due to search convenience of the “ [symbol] ” character system.

Eighth, if a Chinese character is input in stroke order in a combinatorial manner, Chinese character amnesia may be prevented.

Ninth, as multiple shortcut Chinese characters are logically arranged, higher input efficiency may be obtained than with the conventional methods.

Tenth, while the conventional input methods use only one direction key due to order of frequency, the method of the present invention may improve efficiency of inputting Chinese characters as multiple direction keys are used.

Eleventh, with the conventional methods for inputting Chinese characters, a character is selected in the Chinese character list and then input. On the other hand, according to embodiments of the present invention, fonts may be developed to input Chinese characters in a combinatorial manner as in the case of Hangul.

Twelfth, arrangement of Chinese characters in order of frequency used in the conventional input methods has no objective arrangement rule. On the other hand, the arrangement rule of the “ [symbol] ” character system maintains objectiveness for all input methods, and accordingly may improve user convenience.

### DESCRIPTION OF DRAWINGS

FIG. 1 is a block diagram illustrating a configuration of a device for inputting Chinese characters according to an embodiment of the present invention.

FIG. 2 illustrates basic graphemes according to an embodiment of the present invention.

FIG. 3 illustrates the cross relation and facing relation between basic graphemes.

FIG. 4 illustrates extended graphemes based on the slant principle for the basic graphemes according to an embodiment of the present invention.

FIG. 5 illustrates extended graphemes based on the length principle for the basic graphemes according to an embodiment of the present invention.

FIG. 6 illustrates extended graphemes based on the principle of stroke addition for the basic graphemes according to an embodiment of the present invention.

FIG. 7 illustrates extended graphemes based on the principle of protrusion for the basic graphemes according to an embodiment of the present invention.

FIG. 8 illustrates the pyramid structure of graphemes extended from the basic graphemes according to an embodiment of the present invention.

FIGS. 9 to 22 illustrate implementation of graphemes on a keypad according to embodiments of the present invention.

FIG. 23 is a chart illustrating a “ [symbol] ” character system according to the present invention.

FIG. 24 illustrates characters produced in combining graphemes in a “ [symbol] ” character system according to an embodiment of the present invention.

FIG. 25 illustrates a shortcut key list and grapheme direction keys according to the present invention.

FIG. 26 illustrates 214 radicals of the Kangxi dictionary and arrangement order of a “ [symbol] ” character system applied to the present invention.

FIG. 27 illustrates the pyramid structure of a “ [symbol] ” character system of 214 radicals of the Kangxi dictionary applied to the present invention.

FIG. 28 illustrates the Unicode CJK Radicals Supplement and arrangement order of a “ [symbol] ” character system applied to the present invention.

FIG. 29 illustrates the pyramid structure of the Unicode CJK Radicals Supplement applied to the present invention.

FIG. 30 illustrates arrangement order of unified radicals in a “ [symbol] ” character system according to an embodiment of the present invention.

FIG. 31 illustrates a “ [symbol] ” character system with page information about the Kangxi dictionary applied to the present invention.

FIG. 32 illustrates a “ [symbol] ” character system with page information about an unabridged Chinese character dictionary applied to the present invention.

FIG. 33 illustrates a “ [symbol] ” character system with page information about an unabridged Chinese dictionary applied to the present invention.

FIG. 34 illustrates a “ [symbol] ” character system with page information about the dictionary Dai Kan-Wa applied to the present invention.

FIG. 35 illustrates a “ [symbol] ” character system corresponding to radical Unicode number information about Unicode CJK Unified Ideographs applied to the present invention.

FIG. 36 illustrates a “ [symbol] ” character system corresponding to radical Unicode number information about Unicode CJK Unified Ideographs-A applied to the present invention.

FIG. 37 illustrates a “ [symbol] ” character system corresponding to radical Unicode number information about Unicode CJK Unified Ideographs-B applied to the present invention.

FIG. 38 illustrates a “ [symbol] ([i1], one)” radical list of Unicode CJK Unified Ideographs applied to the present invention.

FIG. 39 illustrates a “ [symbol] ([i1], one)” radical list of Unicode CJK Unified Ideographs-A applied to the present invention.

FIG. 40 illustrates a “ [symbol] ([i1], one)” radical list of Unicode CJK Unified Ideographs-B applied to the present invention.

FIG. 41 illustrates a “ [symbol] ” character system for a unified “ [symbol] ([i1], one)” radical list of Unicode CJK Unified Ideographs applied to the present invention.

FIG. 42 illustrates the pyramid structure of a “ [symbol] ” character system for a unified “ [symbol] ([i1], one)” radical list of Unicode CJK Unified Ideographs applied to the present invention.

FIG. 43 illustrates comparison between a conventional cellular phone and a “ [symbol] ” character system according to the present invention.

FIG. 44 illustrates comparison between a conventional cellular phone and a “ [symbol] ” character system for a 2-syllable word with “ [symbol] ” according to the present invention.

FIG. 45 illustrates comparison between a conventional cellular phone and a “ [symbol] ” character system for 2-syllable words according to the present invention

FIG. 46 is a reference diagram of arrangements and combinations according to the present invention.

FIG. 47 illustrates an exemplary arrangement according to the present invention.

FIG. 48 illustrates an exemplary combination according to the present invention.

### BEST MODE

A device for inputting Chinese characters through an information technology (IT) terminal in accordance with the present invention includes a character key including a plurality of keys assigned graphemes which consecutively vary from basic graphemes configured by strokes “ [symbol] ,” “ [symbol] ,” “ [symbol] ,” and “ [symbol] ” constituting a “ [symbol] ” character system, the character key being configured to input corresponding graphemes in a time series through one or more manipulations of the keys; a selection key configured to select graphemes or Chinese characters configurable through manipulation of the character key; a storage unit configured to store the graphemes, characters and Chinese characters, the characters and Chinese characters being formed by combining, in a predetermined order, at least two graphemes selected from among the graphemes; a controller configured to perform a control operation to search the storage unit for the characters and Chinese characters formed by combining the at least two graphemes selected from among the graphemes, the Chinese character selected through the selection key, and a Chinese character input through the character key and generate the same; and a display unit configured to display the graphemes input through the character key, the character or Chinese character selected through the selection key, and the graphemes, characters and Chinese characters generated by the controller.

### MODE FOR INVENTION

As used herein, the term “grapheme” is defined as follows.

A grapheme is a character in the smallest stroke unit that constitutes a Chinese character, which is an ideogram. Particularly, in this disclosure, single stroke characters of “ [symbol] ,” “ [symbol] ,” “ [symbol] ,” and “ [symbol] ” which constitute a stroke order system of the character “ [symbol] ,” are set as basic graphemes. The graphemes may be extended, based on the basic graphemes. For simplicity, characters extended from the basic graphemes are referred to as “extended graphemes.” The extended graphemes will be described in detail below. In this disclosure, all Chinese characters are defined as including at least one grapheme and as being input and searched for by inputting graphemes. The system of graphemes for inputting and searching for Chinese characters according to this definition is referred to as a “ [symbol] ” character system. In the “ [symbol] ”character system, all the aforementioned basic graphemes are defined as having one stroke.

That is, strokes of a Chinese character, which is an ideogram, are taken as graphemes (e.g., a single stroke continuously curved or bent using a writing brush is a grapheme) which are the smallest units, and “ [symbol] ,” “ [symbol] ,” “ [symbol] ,” and “ [symbol] ,” which are strokes constituting the “ [symbol] ” character system among the graphemes, are defined as basic graphemes.

In addition, logical order is imposed on the graphemes in a manner that graphemes whose strokes are continuously curved or bent starting in the same direction or toward the same range are classified into the same grapheme group based on (represented by) one of the basic graphemes.

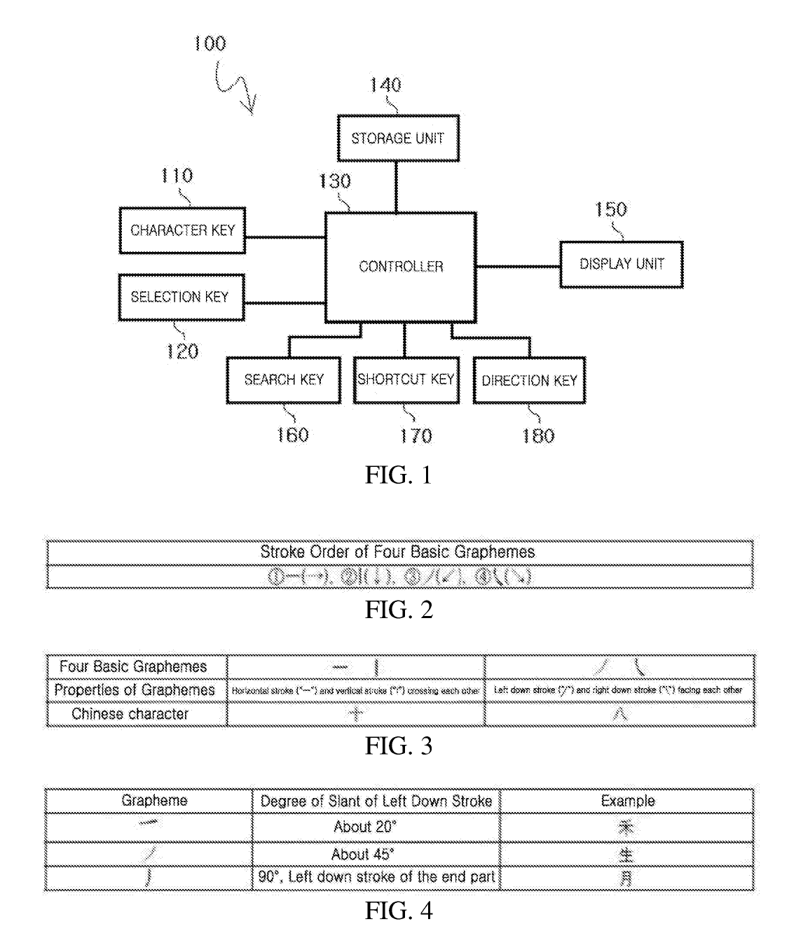

FIG. 1 is a block diagram illustrating configuration of a device for inputting Chinese characters according to an embodiment of the present invention.

Referring to FIG. 1, a Chinese character input device 100 according to an embodiment of the present invention includes a plurality of character keys 110 configured to input graphemes constituting Chinese characters, a plurality of selection keys 120 configured to select one of multiple Chinese characters, a controller configured to perform a control operation to generate graphemes and a Chinese character input and selected through the character keys 110 and the selection keys 120, a storage unit 140 configured to store multiple graphemes, characters formed by combining the graphemes, and Chinese characters, and a display unit 150 configured to display the graphemes and Chinese character generated by the controller 130. According to another embodiment of the present invention, the Chinese character input device 100 may further include a search key 160. According to yet another embodiment of the present invention, the Chinese character input device 100 may further include a shortcut key 170 and a direction key 180.

The character keys 110 are assigned one or more graphemes. The graphemes are configured to be input through the character keys 110. The graphemes include “ [symbol] ,” “ [symbol] ,” “ [symbol] ,” and “ [symbol] ,” In another example, the graphemes may be extended to include 4 to 46 graphemes including “ [symbol] ,” “ [symbol] ,” “ [symbol] ,” and “ [symbol] ”. The graphemes will be described in detail below.

The “ [symbol] ” character system according to the present invention is determined based on the following.

1) As shown in FIG. 2, the character “ [symbol] ” is at the center of the “ [symbol] ” character system. “ [symbol] , ” “ [symbol] ,” “ [symbol] ,” and “ [symbol] ” constituting the “ [symbol] ” character system are configured as basic graphemes. These basic graphemes are defined as having one stroke. Graphemes extended from the basic graphemes are also defined as having one stroke.

2) A cross relation and facing relation are established among the four basic graphemes, as shown in FIG. 3. That is, the cross relation between “ [symbol] ” and “ [symbol] ” is established as “ [symbol] ”, and the facing relation between “ [symbol] ,” and “ [symbol] ” is established as “ [symbol] ”.

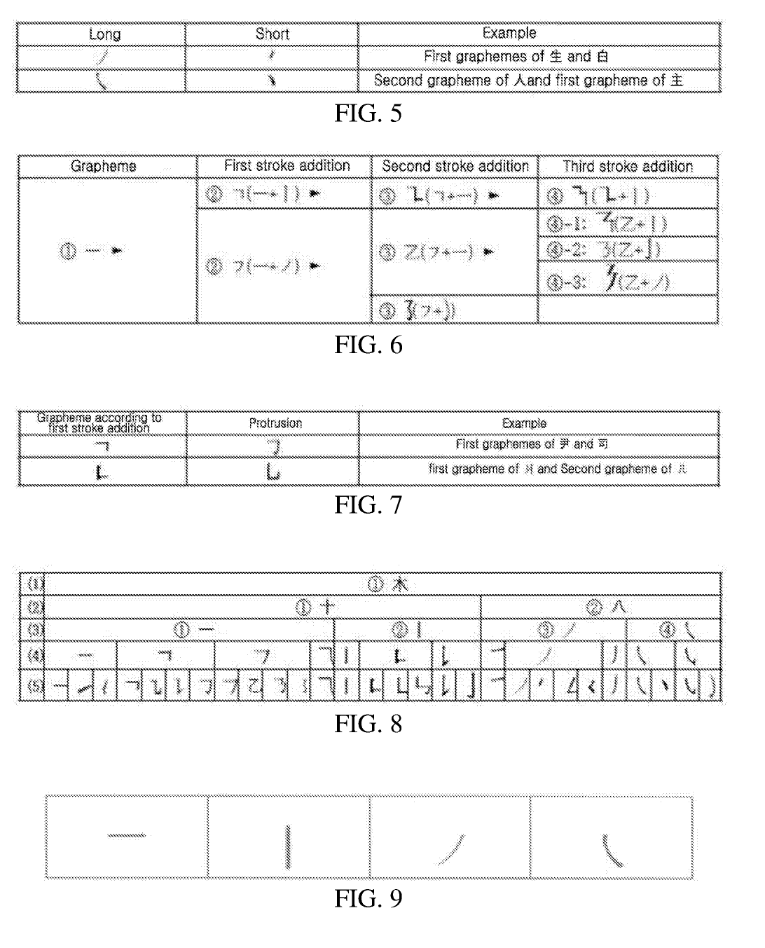

3) Graphemes extended based on the four basic graphemes are distinguished from each other by the slant principle of FIG. 4, the length principle of FIG. 5, the principle of stroke addition FIG. 6, and the protrusion principle of FIG. 7. Several principles of the aforementioned principles may be applied to the same grapheme. Specifically, according to the slant principle of FIG. 4, three extended graphemes may be derived from “ [symbol] ” according to the degree of slant. According to the length principle of FIG. 5, one extended grapheme with a shorter stroke than “ [symbol] ” may be derived from “ [symbol] ”, and one extended grapheme with a shorter stroke than “ [symbol] ” may be derived from “ [symbol] ”. In addition, according to the principle of stroke addition of FIG. 6, extended graphemes may be obtained through first, second and third stroke addition operations. According to the protrusion principle of FIG. 7, one extended grapheme with a protrusion may be derived from each of the graphemes obtained through the first stroke addition operation of FIG. 6.

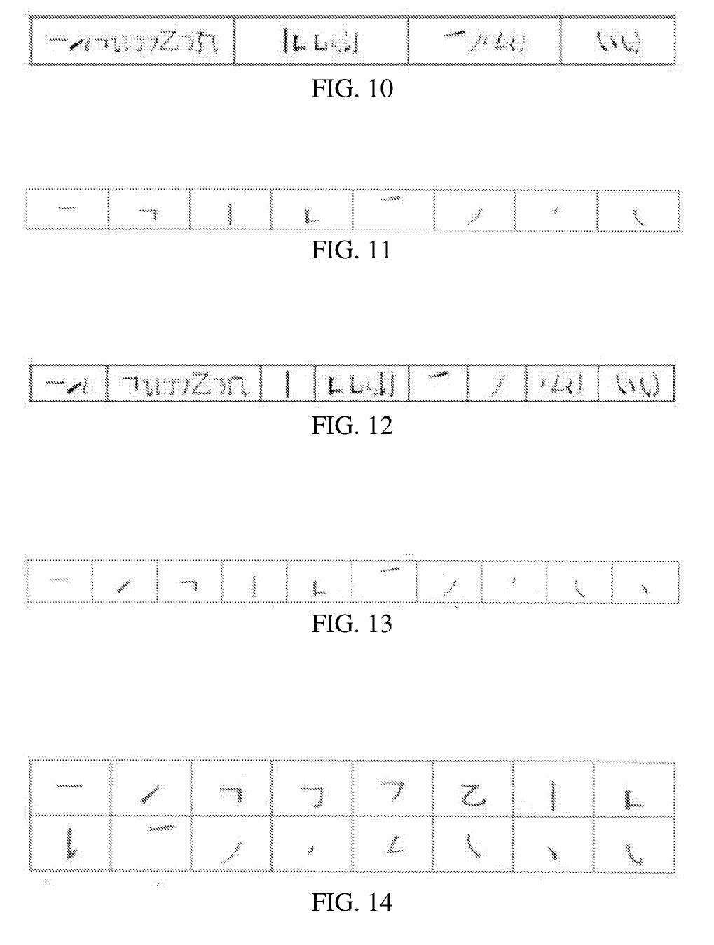

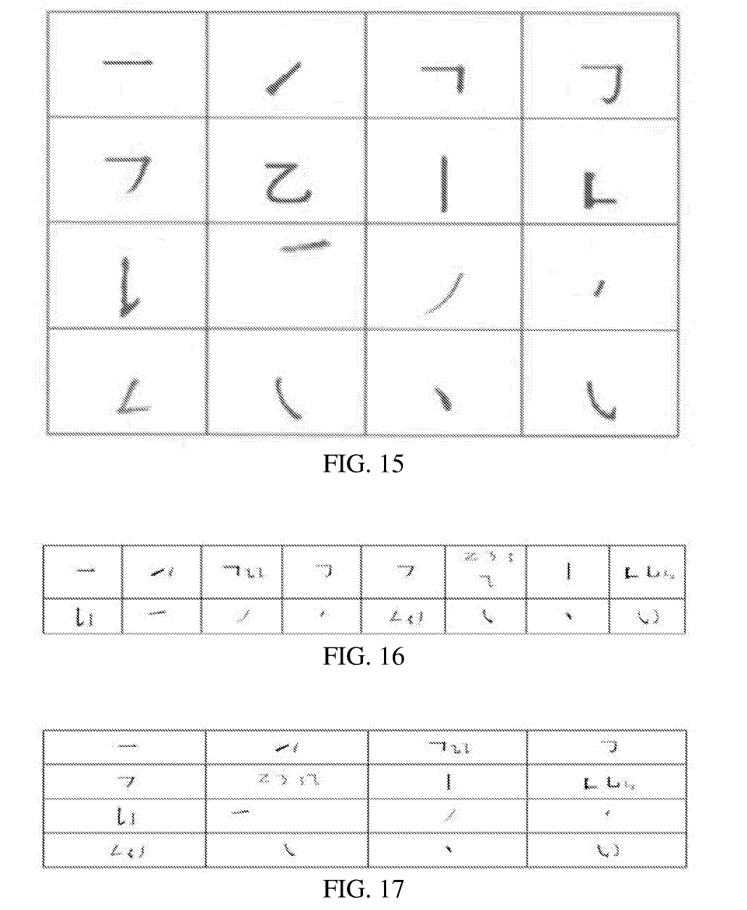

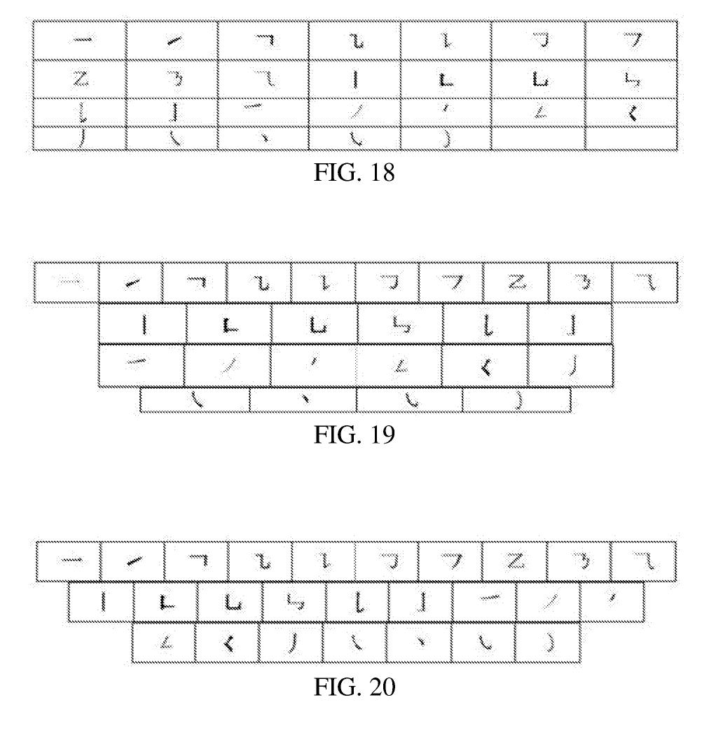

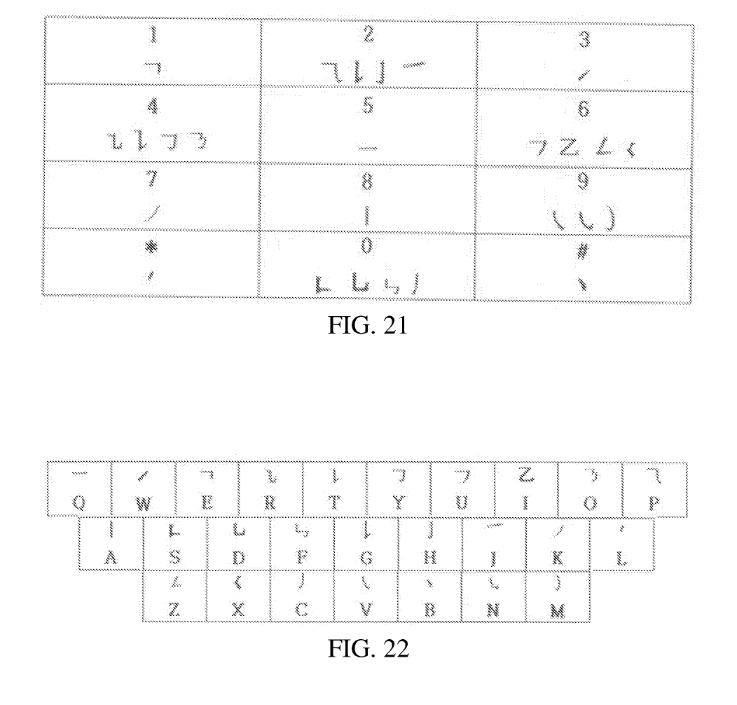

4) The graphemes extended from the basic graphemes “ [symbol] ,” “ [symbol] ,” “ [symbol] ” and “ [symbol] ” in five steps in the form of a pyramid are summarized in FIG. 8. In this embodiment, a grapheme selected from among 28 graphemes including the four basic graphemes is allocated to the character keys 110. In this case, at least one grapheme may be allocated to the multiple character keys 110. Examples of the character keys 110 are shown in FIGS. 9 to 22. FIGS. 21 and 22 show graphemes implemented on a portable terminal and a keyboard.

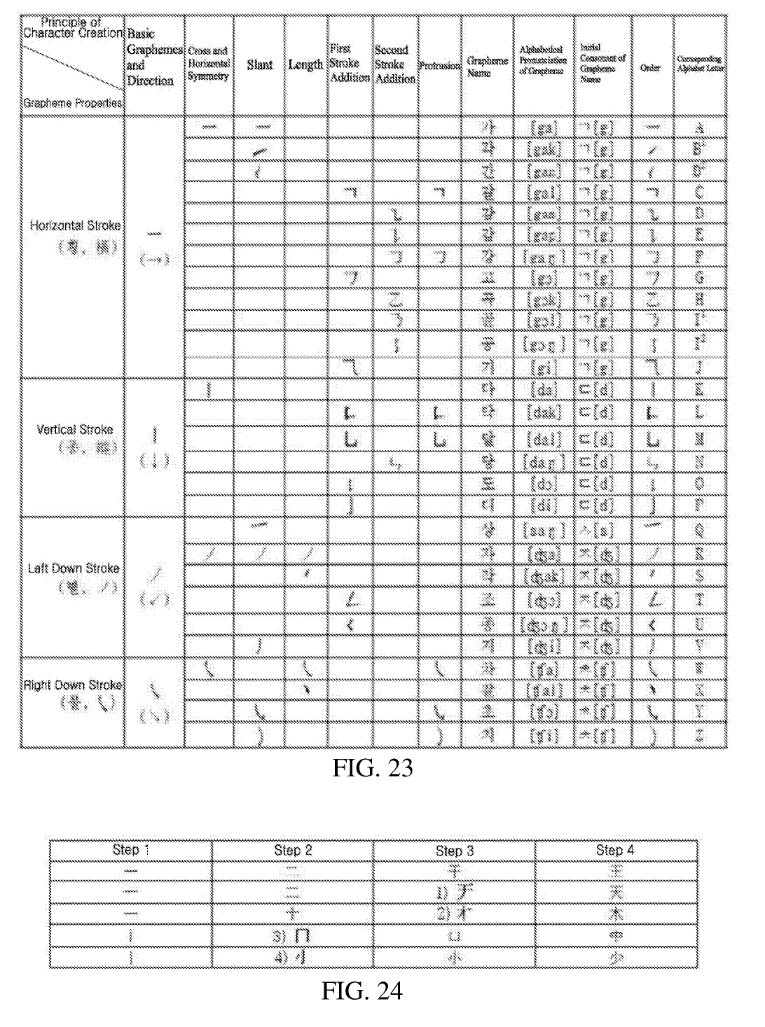

5) In the present invention, the graphemes of the “ [symbol] ” character system are sequentially arranged according to the aforementioned principles of character creation such that the graphemes correspond to the 26 letters of the English alphabet. This correspondence relation is illustrated in FIG. 23. Using this correspondence relation, the graphemes corresponding to the 26 letters of the English alphabet may be formed on, for example, a keyboard. In this case, by inputting graphemes corresponding to letters of the English alphabet, a character or Chinese character may be input. For example, to input “ [symbol] ”, the keys for letters “VAABKAAA” corresponding to the graphemes of “ [symbol] ” need to be pressed. Preferably, the 28 graphemes may be determined in an order as shown in FIG. 23.

6) Although not shown in the figures, such graphemes may be extended to include meaningful graphemes among over 100,000 characters including variant characters, abbreviations, simplified Chinese characters as well as over 70,000 characters of the Unicode CDK Unified Ideographs. For example, the graphemes may be extended to include 46 graphemes “ [symbol] (A),” “ [symbol] (B¹),” “ [symbol] (B²),” “ [symbol] (C),” “ [symbol] (D¹),” “ [symbol] (D²),” “ [symbol] (D³),” “ [symbol] (E),” “ [symbol] (F),” “ [symbol] (G),” “ [symbol] (H),” “ [symbol] (I¹),” “ [symbol] (I²),” “ [symbol] (I³),” “ [symbol] (I⁴),” “ [symbol] (I⁵),” “ [symbol] (I⁶),” “ [symbol] (J),” “ [symbol] (K),” “ [symbol] (L),” “ [symbol] (M),” “ [symbol] (N¹),” “ [symbol] (N²),” “ [symbol] (N³),” “ [symbol] (O),” “ [symbol] (P¹),” “ [symbol] (P²),” “ [symbol] (P³),” “ [symbol] (P⁴),” “ [symbol] (Q),” “ [symbol] (R),” “ [symbol] (S),” “ [symbol] (T¹),” “ [symbol] (T²),” “ [symbol] (T³),” “ [symbol] (U¹),” “ [symbol] (U²),” “ [symbol] (U³),” “ [symbol] (V),” “ [symbol] (W),” “ [symbol] (X),” “ [symbol] (Y¹),” “ [symbol] (Y²),” “ [symbol] (Z¹),” “ [symbol] (Z²),” “ [symbol] (Z³).”

For the 46 extended graphemes, the number of graphemes may be adjusted according to the device such as a keyboard or keypad. To match the graphemes with the most typical 26 keys, the graphemes may be reduced to 26 representative graphemes. That is, the graphemes may be reduced to 26 graphemes “ [symbol] (A),”“ [symbol] (B),” “ [symbol] (C),” “ [symbol] (D),” “ [symbol] (E),” “ [symbol] (F),” “ [symbol] (G),” “ [symbol] (H),” “ [symbol] (I),” “ [symbol] (J),” “ [symbol] (K),” “ [symbol] (L),” “ [symbol] (M),” “ [symbol] (N),” “ [symbol] (O),” “ [symbol] (P),” “ [symbol] (Q),” “ [symbol] (R),” “ [symbol] (S),” “ [symbol] (T),” “ [symbol] (U),” “ [symbol] (V),” “ [symbol] (W),” “ [symbol] (X),” “ [symbol] (Y),” and “ [symbol] (Z).” Even if the number of graphemes is reduced depending on IT devices, order of arrangement of the 46 graphemes according to the principles of character creation does not change. The logical structure of the “ [symbol] ” character system according to the principles of character creation is summarized in FIG. 23. Although the graphemes of the “ [symbol] ” character system do not have phonetic value, most of Chinese characters may be established and input by arranging or combining the graphemes.

7) In the present invention, 28 graphemes are assigned names. In addition, the 28 graphemes are configured to include “ [symbol] ” “ [symbol] ,” “ [symbol] ,” “ [symbol] ” “ [symbol] ,” or “ [symbol] ” as final consonants thereof. The initial phonemes of the 4 basic graphemes are consonants “ [symbol] [g],” “ [symbol] [d],” “ [symbol] [s]/ [symbol] [d₃],” and “ [symbol] [t∫].” Sub-graphemes share an initial phoneme and represent one group. In addition, the final sound of each name of the 4 basic graphemes has a rhythm of “ [symbol] [i]”. That is, the final sounds of the 4 basic graphemes are “ [symbol] [gi],” “ [symbol] [di],” “ [symbol] [d₃i],” and “ [symbol] [t∫i]”, by which the 4 basic graphemes are divided into 4 groups.

8) In this way, the graphemes are named “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” and “ [symbol] ,” according to the naming rule for the graphemes, as shown in FIG. 23.

9) The “ [symbol] ” character system according to the present invention is established based on all the aforementioned principles of character creation.

10) In distinguishing among the graphemes, the 4 basic graphemes “ [symbol] ,” “ [symbol] ,” “ [symbol] ,” and “ [symbol] ” may be allocated to the character keys, or the graphemes may be divided, for simplicity, into a first grapheme group represented by “ [symbol] ” and including “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” and “ [symbol] ,”, whose strokes start to be written in the same direction, a second grapheme group represented by “ [symbol] ” and including “ [symbol] ,” “ [symbol] ,” “ [symbol] ,” “ [symbol] .” “ [symbol] ,” and “ [symbol] ,” whose strokes start to be written in the same direction, a third grapheme group represented by “ [symbol] ” and including “ [symbol] ,” “ [symbol] ,” “ [symbol] ,” “ [symbol] ,” “ [symbol] ,” and “ [symbol] ,” whose strokes start to be written in the same direction, and a fourth grapheme group represented by “ [symbol] ” and including “ [symbol] ,” “ [symbol] ,” “ [symbol] ,” and “ [symbol] ,” whose strokes start to be written in the same direction, and allocated to the character keys, respectively.

11) Among the grapheme groups represented by the basic graphemes “ [symbol] ,” “ [symbol] ,” “ [symbol] ,” and “ [symbol] ” the first grapheme group may be extended to include a first extended grapheme group consisting of “ [symbol] ,” “ [symbol] ,” “ [symbol] ,” “ [symbol] ,” “ [symbol] ,” and “ [symbol] ,” the second grapheme group may be extended to include a second extended grapheme group consisting of “ [symbol] ,” “ [symbol] ,” “ [symbol] ,” “ [symbol] ,” and “ [symbol] ,” the third grapheme group may be extended to include a third extended grapheme group consisting of “ [symbol] ,” “ [symbol] ,” “ [symbol] ,” and “ [symbol] ,” and the fourth grapheme group may be extended to include a fourth extended grapheme group consisting of “ [symbol] ,” “ [symbol] ,” and “ [symbol] ” The graphemes of the first to fourth extended grapheme groups may be allocated to the character keys such that the extended graphemes are input through multiple manipulations of the character keys.

Subsequently, multiple graphemes configured by the “ [symbol] ” character system may be input through the character keys 110, and an intended Chinese character may be input through input of the graphemes. To this end, for example, at least one grapheme may be allocated to the character keys 110 such that the corresponding grapheme can be input by pressing the character keys 110. Such character keys may be implemented as, for example, key buttons of a keyboard, a keypad, or the like.

The selection keys 120 are configured to select a Chinese character to be input among multiple Chinese characters including the Chinese character consisting of at least one grapheme input through the character keys 110. The selection keys 120 may also be implemented as, for example, key buttons.

The controller 130 performs a control operation to generate and input, through the Chinese character input device 100, the graphemes and/or Chinese character input through the character keys 110. In addition, the controller 130 performs a control operation to generate a grapheme and/or Chinese character selected through the selection keys 120. The generated grapheme and Chinese character are input to the Chinese character input device 100. The controller 130 may be implemented as software.

The storage unit 140 pre-stores multiple graphemes, characters formed by combining graphemes, Chinese characters, and the like. The storage unit 140 also includes information about the Chinese characters. Preferably, the storage unit 140 stores not only the graphemes and Chinese characters input through the character keys but also characters formed by combining graphemes consecutively input through the character keys 110. For example, when the graphemes “ [symbol] ,” “ [symbol] ,” “ [symbol] ,” and “ [symbol] ” are sequentially input one by one to input “ [symbol] ”, the graphemes are sequentially combined to input characters formed by combination, namely, “ [symbol] ,” “ [symbol] ,” “ [symbol] ,” “ [symbol] .” When a character formed by combining graphemes as above is displayed, a character which is neither a grapheme nor a Chinese character may be input. Accordingly, the storage unit 140 preferably stores graphemes which may be generated in the procedure of inputting a Chinese character, characters formed by combining graphemes, and Chinese characters. The storage unit 140 also includes information about all Chinese characters. Such Chinese character information includes pronunciation, meaning, and an example sentence for each Chinese character.

The display unit 150 displays graphemes, a character formed by combining at least one grapheme, a Chinese character, and the like. The display unit 150 may be implemented by a display apparatus such as, for example, a liquid crystal display (LCD). According to an embodiment of the present invention, the display unit 150 may be integrated with the character keys 110 as in the case of a touchpad and touchscreen. According to another embodiment, the selection keys 120 may also be integrated with the character keys 110 and the display unit 150 as in the case of a touchpad and touchscreen.

The search key 160 is configured to search for information about a Chinese character displayed on the display unit 150 and display the information on the display unit 150. Herein, the information about the Chinese character may include pronunciation, meaning and an example sentence. Such information about the Chinese characters may be used for the user to obtain the meaning of a Chinese character.

If a Chinese character includes a component Chinese character, the shortcut key 170 is allocated to the component Chinese character. Thereby, if the component Chinese character is input first, and then the shortcut key 170 is pressed, multiple Chinese characters starting with the component Chinese character may be displayed such that an intended Chinese character can be input among the displayed Chinese characters. For example, suppose that “ [symbol] ” is allocated to a shortcut key, and “ [symbol] ” needs to be input. In this case, “ [symbol] ” is input, and then the shortcut key of “ [symbol] ” is pressed. Then, Chinese characters with “ [symbol] ”, for example, “ [symbol] ,” “ [symbol] ,” “ [symbol] ,” “ [symbol] ,” and the like will be displayed. Then, “ [symbol] ” may be selected and input among the displayed Chinese characters.

In the case where not all desired Chinese characters can be displayed due to the limited size of the display unit 150, the direction key 180 is pressed with only some of the desired Chinese characters displayed to display the other Chinese characters which were hidden. In this way, if there are many Chinese characters to be displayed, only some thereof may be displayed and the other Chinese characters may be configured to be additionally displayed when an input is provided through the direction key 180.

Hereinafter, a procedure of inputting Chinese characters in the Chinese character input device 100 configured as above will be described. In this embodiment, an intended Chinese character is input using the character keys 110 in stroke order of the graphemes constituting the Chinese character. As the graphemes are input one by one through the character keys 110, characters formed by combining the graphemes are displayed on the display unit 150 one after another. For “ [symbol] ”, for example, when “ [symbol] ,” “ [symbol] ,” “ [symbol] ,” and “ [symbol] ,” are sequentially input, the display unit 150 displays combinations of the graphemes, namely, “ [symbol] ,” “ [symbol] ,” “ [symbol] ,” and “ [symbol] ” one after another, rather than displaying “ [symbol] ,” “ [symbol] ,” “ [symbol] ,” and “ [symbol] ” each time an input is provided. Similarly, to configure “ [symbol] ,” “ [symbol] ,” “ [symbol] ,” and “ [symbol] ,” characters such as 1) “ [symbol] ,” 2) “ [symbol] ,” 3) “ [symbol] ,” and 4) “ [symbol] ” are needed. Although such characters are not commonly used, they are displayed on the screen. Accordingly, in this embodiment, characters representing the respective input steps are pre-stored to allow input of all Chinese characters, and the fonts are displayed on the display unit 150 as graphemes are consecutively input. Thereby, the user can directly check the procedure of combination of the graphemes while inputting the graphemes. Accordingly, once all fonts for the Chinese characters are created, any Chinese character may be expressed in a combinatorial manner, as shown in FIG. 24.

In addition, according to this embodiment, when a Chinese character is input, other Chinese characters starting with the input Chinese character are pre-displayed on the display unit 150. For example, when “ [symbol] ” is input, Chinese characters such as “ [symbol] ,” “ [symbol] ,” and “ [symbol] ” are displayed, starting with “ [symbol] .” Then, the intended Chinese character may be selected from among the displayed Chinese characters, using the selection keys 120.

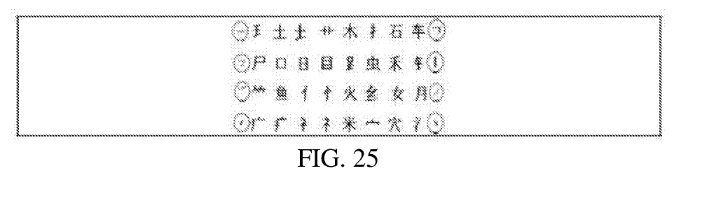

As described above, the shortcut key 170 is configured to easily and quickly input Chinese characters. In this embodiment, a list of the shortcut keys 170 may be basically displayed on the initial screen image of a keyboard or keypad, as shown in FIG. 25. The representative Chinese characters in between “ [symbol] ” and “ [symbol] ” in FIG. 25 serve as the shortcut key 170 that guide directly to component Chinese characters. That is, the shortcut key 170 may be allocated to a specific Chinese character among the multiple Chinese characters displayed on the display unit 150. For example, suppose that “ [symbol] ” is set as the shortcut key, and “ [symbol] ” needs to be input. In this case, when “ [symbol] ” is input, and then “ [symbol] ” set as the shortcut key is selected, all Chinese characters starting with “ [symbol] ” are displayed and “ [symbol] ” can be input by selecting “ [symbol] ” from among the displayed Chinese characters. Of course, if the shortcut key is not used, the corresponding Chinese character may be input by sequentially inputting “ [symbol] ,” “ [symbol] ” and “ [symbol] ” in stroke order. The shortcut keys between “ [symbol] ” and “ [symbol] ” indicate that there is a list of Chinese characters having the highest frequency and starting with the respective graphemes. The Chinese characters having high frequencies shall conform to the arrangement order of the “ [symbol] ” character system. The representative Chinese characters of the shortcut keys represent not only the radicals. For example, although the radical of “ [symbol] ” is “ [symbol] ,” “ [symbol] ” belongs to the shortcut Chinese character “ [symbol] ” because the strokes of “ [symbol] ” start with “ [symbol] .” That is, the representative Chinese character “ [symbol] ” serving as a shortcut key represents all Chinese characters whose strokes start with “ [symbol] .” To input “ [symbol] ,” “ [symbol] ” that comes first, after the representative character “ [symbol] ” on the initial screen is pressed, is pressed. That is, “ [symbol] ” may be input through two inputs. Other shortcut Chinese characters also operate in the same way. The Chinese characters serving as the shortcut keys may be identified by a color or style.

Arrangement of graphemes of the shortcut keys and combinational fonts is based on the “ [symbol] ” character system as in the case of arrangement of the letters A, B, C, D, E, F, G, and H. If a Chinese character that may come first is arranged in place of the graphemes between “ [symbol] ” and “ [symbol] ” the position of a Chinese character having a high frequency may be pinpointed. This is conceptually identical to intuitively recognizing that the English word “BOOK” belongs to the “B” section.

When the shortcut key 170 is pressed, the keyboard or keypad will temporarily disappear, and more than 50 to 100 component Chinese characters (including Chinese characters allocated to the shortcut keys 170) will be displayed on the whole screen. If a symbol for returning from the whole screen to the initial screen is provided, the input operation may be very easily and promptly performed. For example, if 100 basic characters are arranged, 800 characters having high frequencies may be unconditionally input through two inputs. According to general statistics, 800 characters make up 80% of all sentences. Herein, if a list of characters or words with a selected Chinese character is set to be continuously displayed on the whole screen when the selected Chinese character is displayed, input efficiency may be maximized.

A keyboard through which the input operation is to be performed using the “ [symbol] ” character system may be implemented with 4 to 28 key buttons depending on the shape of the keyboard. However, embodiments of the present invention are not limited to such arrangement or shape. The keyboard may be determined to have various shapes according to the shapes of IT devices, as necessary.

In addition, according to an embodiment, a component Chinese character may be input using a shortcut Chinese character. The shortcut Chinese character is assigned to a specific Chinese character among Chinese characters displayed on the display unit 150 according to an order of the “ [symbol] ” character system.

In accordance with another aspect of the present invention, a Chinese character search method using the aforementioned Chinese character input device is provided. According to the Chinese character search method, when a Chinese character is input through the Chinese character input device, an input is provided through the search key 160. Then, information about the Chinese character is displayed. Herein, information about the Chinese character includes pronunciation, meaning and an example sentence.

Application of the “ [symbol] ” character system according to this embodiment to the conventional search method and input method may achieve a synergistic effect. Three major search and input methods among many methods are described below.

(1) According to the conventional search-by-radicals method and radical input method, the total stroke number of a radical is checked in a radical table, and then the remaining strokes are counted to search for or input the intended Chinese character. In contrast, using the “ [symbol] ” character system eliminates the need for the radical table and counting of the remaining strokes.

(2) If the “ [symbol] ” character system is applied to the search-by-total strokes method and total stroke input method, the search and input operations may be performed without any auxiliary means such as the 5 strokes.

(3) The search-by-pronunciation (pinyin pronunciation, Bopomofo pronunciation, pronunciation of a word indicating the meaning of a character, or pronunciation of the character) method requires four tones, order of total strokes, order of radicals or order of strokes as auxiliary means depending on the situation. However, if the “ [symbol] ”character system is applied to this method, a list of Chinese characters may be intuitively searched and input after search by pronunciation is performed. With the “ [symbol] ”character system, unity of arrangement order may be maintained, and thus users may easily perform the search and input operations.

In addition, in this embodiment, “ [symbol] ” and “ [symbol] ” in 3-stroke Chinese characters “ [symbol] ” and “ [symbol] ”, which are considered to have 2 strokes respectively in the traditional system of 214 radicals, but considered to have one stroke in the simplified Chinese character system, conform to the character creation principle in item 1), and are thus taken as some graphemes of 46 graphemes. As such, characters that have total strokes which may vary among nations and times, but are classified into one-stroke characters may be accepted as graphemes.

For some Chinese characters, graphemes may vary depending on style or national standard. For example, for a traditional Chinese character “ [symbol] (=VAABKAAA),” the first grapheme “ [symbol] ” corresponds to the letter “V.” However, for a Chinese character “ [symbol] (=KAAAKAAA),” which is the simplified form of “ [symbol] ,” the first grapheme “ [symbol] ” corresponds to the letter “K.” As another example, a Taiwanese version of “ [symbol] (=VFAA)” is “ [symbol] (=VFXB).” Since the graphemes differ between “ [symbol] ” and “ [symbol] ”, these characters are treated as different characters. As such, since a grapheme changed according to the environment has a different shape, the graphemes are independently classified.

If stroke order changes from one nation to another, all stroke orders for the respective nations may also be reflected. For example, strokes of “ [symbol] ” or “ [symbol] ” are ordered as “ [symbol] ,” “ [symbol] ,” “ [symbol] ,” “ [symbol] ,” and “ [symbol] ” (=KCAKA) in China, while they are ordered as “ [symbol] ,” “ [symbol] ,” “ [symbol] ,” “ [symbol] ,” and “ [symbol] ” (=KCKAA) in Japan. That is, the third stroke in stroke order differs between China and Japan. As another example, strokes of “ [symbol] ” or “ [symbol] ” (in, for example, “ [symbol] ” or “ [symbol] ”) are ordered as \textcircled{1} “ [symbol] ,” \textcircled{2} “ [symbol] ,” \textcircled{3} “ [symbol] ,” and \textcircled{4} “ [symbol] ” (=AAKA) in China, while they are ordered as \textcircled{1} “ [symbol] ,” \textcircled{2} “ [symbol] ,” \textcircled{3} “ [symbol] ,” and \textcircled{4} “ [symbol] ” (=AKAA). The Chinese character dictionary or Chinese dictionary may be individually published and applied to IT products according to stroke order for each nation. Alternatively, the Chinese character dictionary or Chinese dictionary may be created considering stroke orders for all nations. Thereby, the dictionary may be applied to any search and input method even if stroke order frequently changes.

### EMBODIMENT 1

Hereinafter, a description will be given of application of the “ [symbol] ” character system to the method of search by radicals. If Chinese characters are matched with a list of all radicals including variants produced over time, the search operation may be performed without inconvenience even if the radical of a character changes. For example, a user who is aware of the traditional Chinese character “ [symbol] ([si], to see)” only needs to use the radical “ [symbol] ([gj [symbol] n], to see)” to search for the character, and a user who is aware of the simplified Chinese character “ [symbol] ([si], to see)” only needs to use the radical “ [symbol] ([si], to show)” to search for the character. As another example, a user who is aware of the traditional Chinese character “ [symbol] ([gun], military)” only needs to use the radical “ [symbol] ([g [symbol] ], a rickshaw) to search for the character, and a user who is aware of the simplified Chinese character “ [symbol] ([gun], military)” only needs to use the radical [symbol] ([mj [symbol] k], to cover)” to search for the character. Accordingly, if all radicals to which a Chinese character belongs are listed as described above, a user can easily find the character using only a radical that the user is aware of even if the character belongs to different radicals.

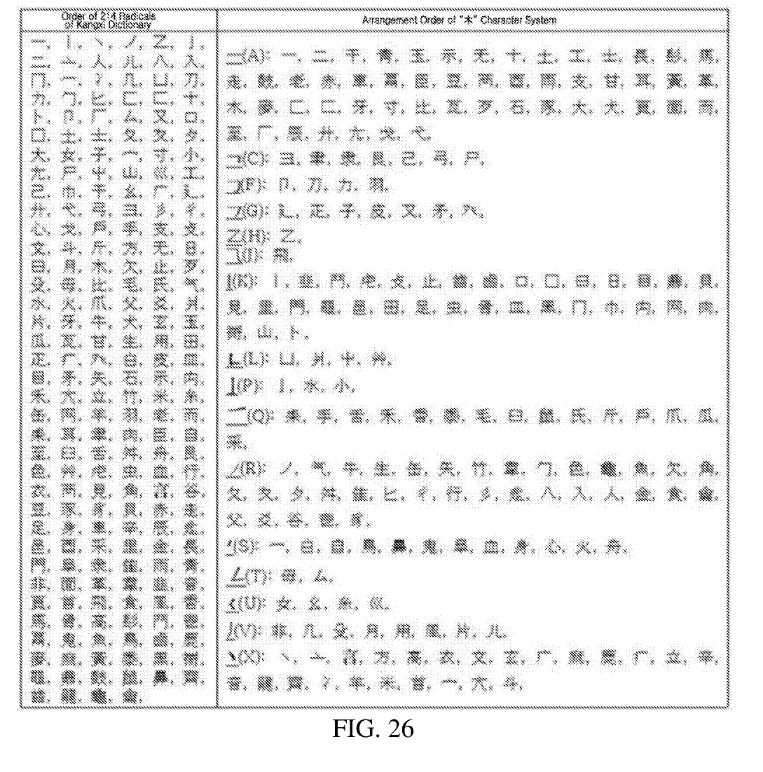

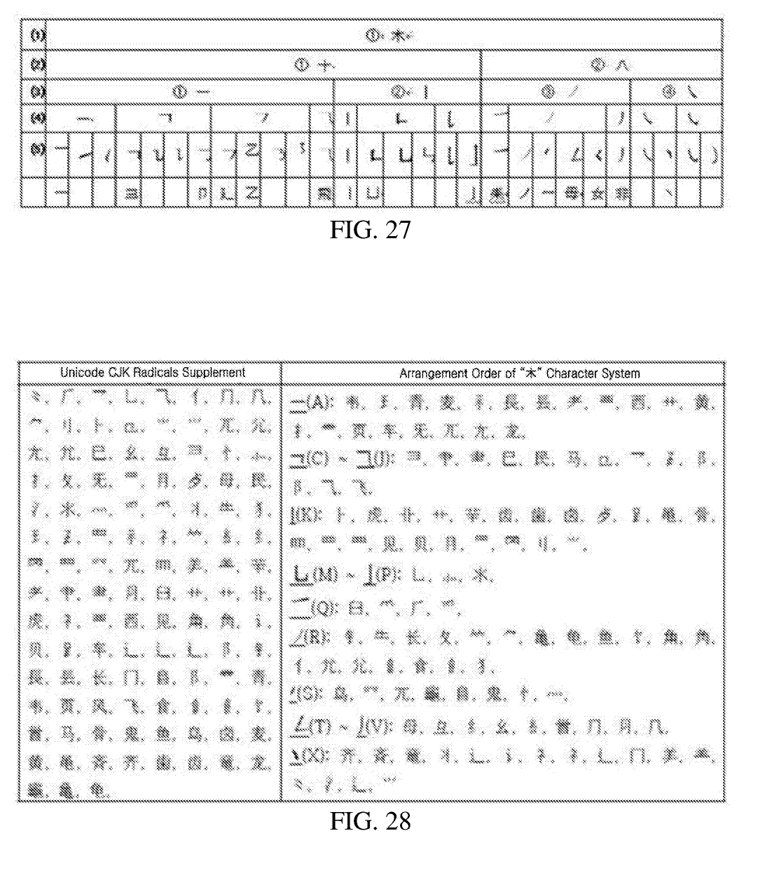

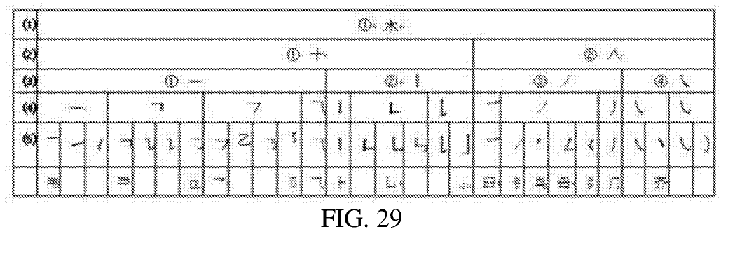

214 radicals of Kangxi dictionary, which are most widely used as a radical table, may be summarized according to the “ [symbol] ” character system, as shown in FIG. 26. If all Chinese characters are searched for using the list of radicals arranged in the pyramid structure of the “ [symbol] ” character system, the need for a radical table is eliminated. As the need for a radical table is eliminated, the total strokes of a radical becomes meaningless, and the operation of counting the remaining strokes, which causes inconvenience, becomes unnecessary. The CJK Radicals Supplement is a collection of new added radicals obtained by varying the number of radicals rather than using the 214 traditional radicals, which cause inconvenience in performing the search operation. When the CJK Radicals Supplement is summarized according to the “ [symbol] ” character system, the arrangement order of FIG. 28 and the pyramid structure of FIG. 29 are obtained.

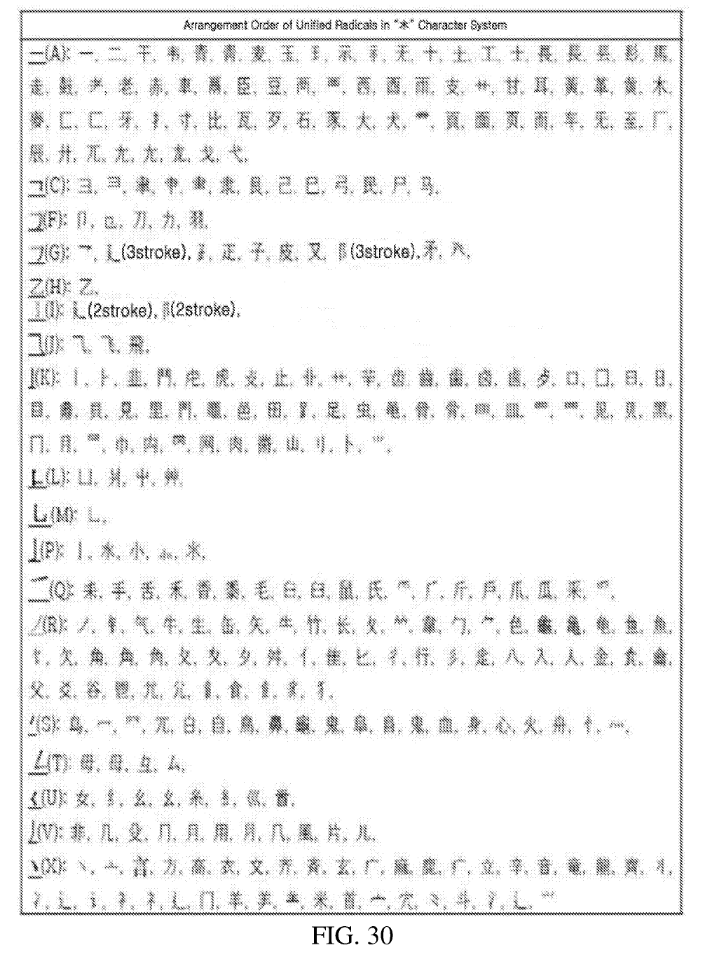

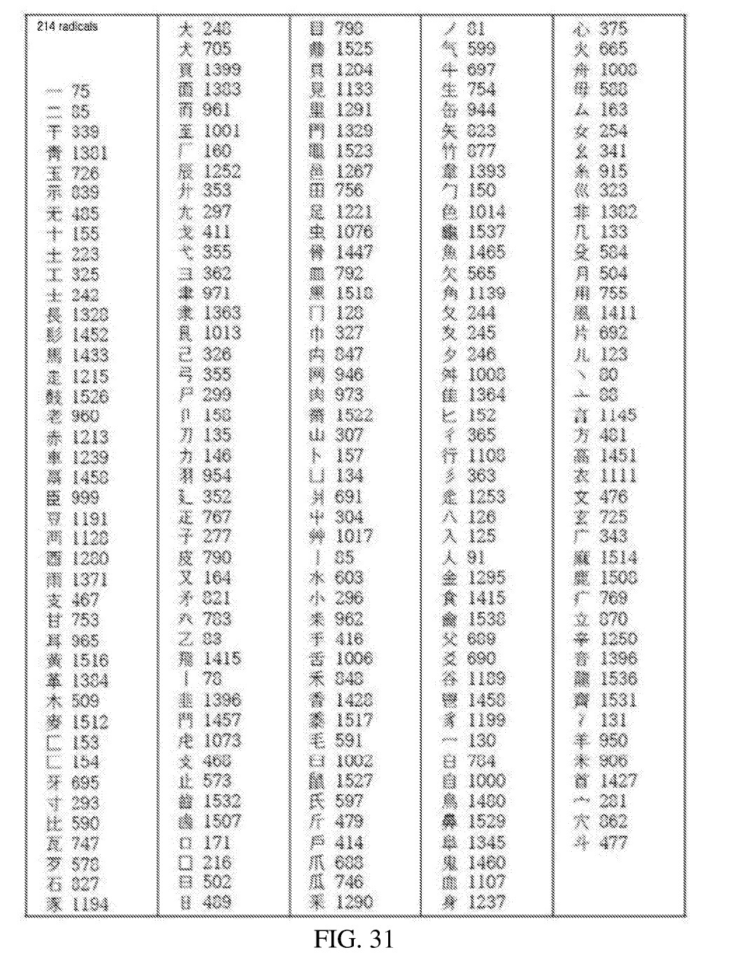

FIG. 30 shows a unified radical list, which includes all variant radicals produced so far and is obtained by combining the 214 radicals and the CJK Radicals Supplement. If a character is classified not only into a conventional radical but also into a variant radical added according to change in the radicals, a user can search for the character using only a radical that the user is aware of. Even if another radical is added in the future, search by radicals will raise no problem as long as the radicals are arranged according to the “ [symbol] ” character system. Preferably, changes in the radicals are marked for reference.

All the conventional lists of radicals enable the search operation since page information about the radicals is included in all dictionaries including the Chinese character dictionary and the Chinese dictionary. With Unicode, however, it takes a long time to perform the search operation since the Unicode number information on the radicals in the list is not provided. On the other hand, the “ [symbol] ” character system does not require Unicode number information about the radicals because an intended character can be searched for with graphemes as in the case of the English alphabet. The search and input operations can be performed not only in all books with a list of radicals but also in Unicode in the same manner as searching for a word in the English dictionary.

Unicode has 75,753 registered Chinese characters including 20,902 characters of Chinese, Japanese, and Korean (CJK) Unified Ideographs, 6,582 characters of CJK Unified Ideographs Extension-A, 42,711 characters of CJK Unified Ideographs Extension-B, 4,220 characters of CJK Unified Ideographs Extension-C, 467 characters of CJK Compatibility Ideographs, 214 radicals of Kangxi dictionary, 116 characters of CJK Radicals Supplement, and 542 characters of CJK Compatibility Ideographs Supplement, and the registered Chinese characters are still increasing to Extension-D and Extension-E. These Chinese characters are arranged based on radicals, and accordingly it is very difficult to perform the search operation. Moreover, it is not possible to pinpoint a radical to which an intended Chinese character belongs. If the lists of radicals are arranged according to the “ [symbol] ” character system, on the other hand, characters may be intuitively searched for. Further, if a unified list is created by integrating separated lists, the intuitive search operation may be further facilitated. In addition, when the user desires to know a group to which an individual Chinese character belongs in the unified list, the group information about the Chinese character may be provided to the user.

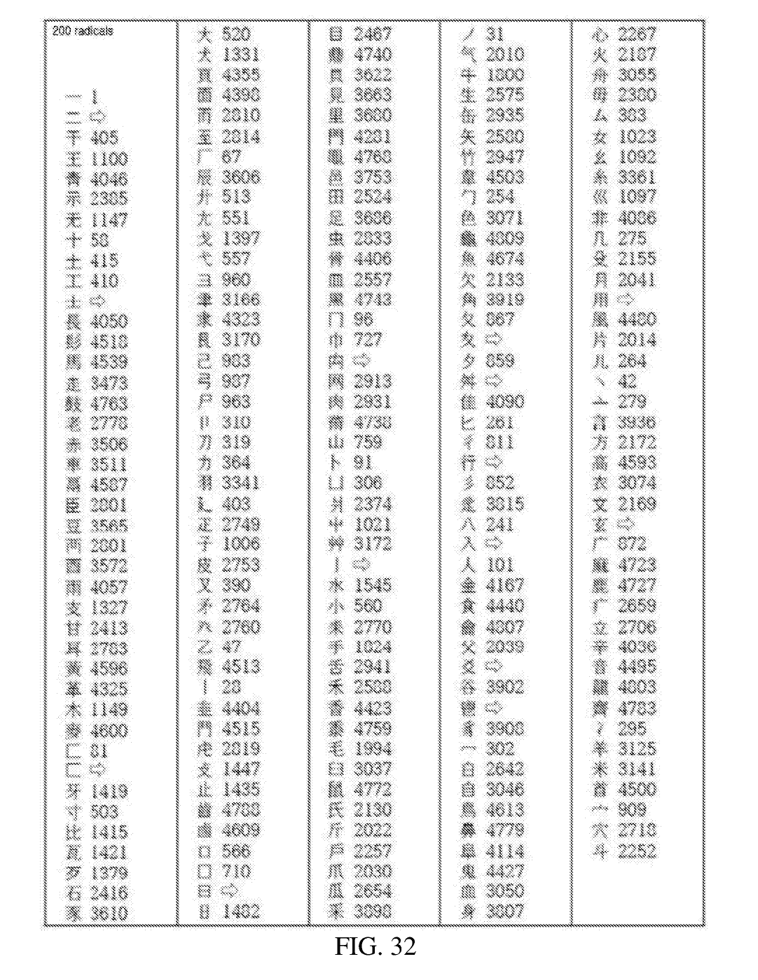

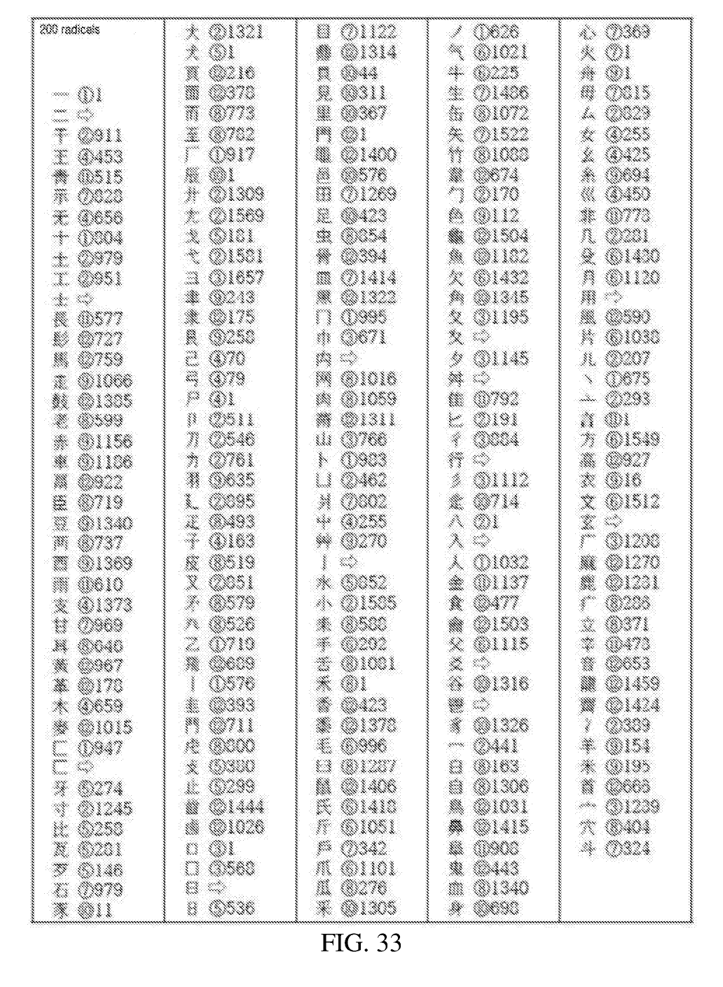

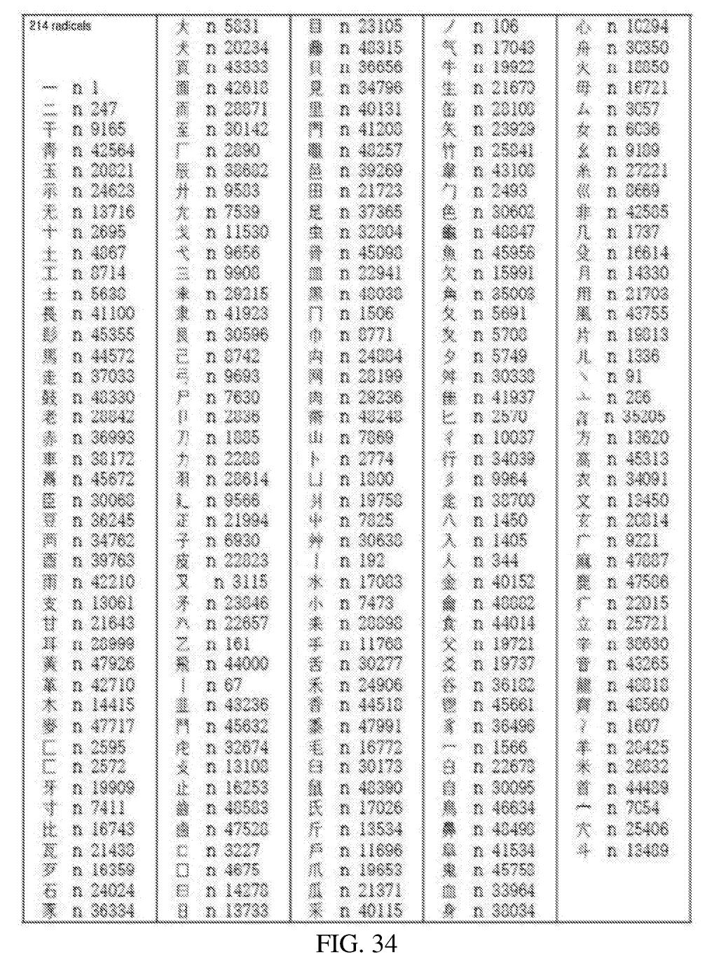

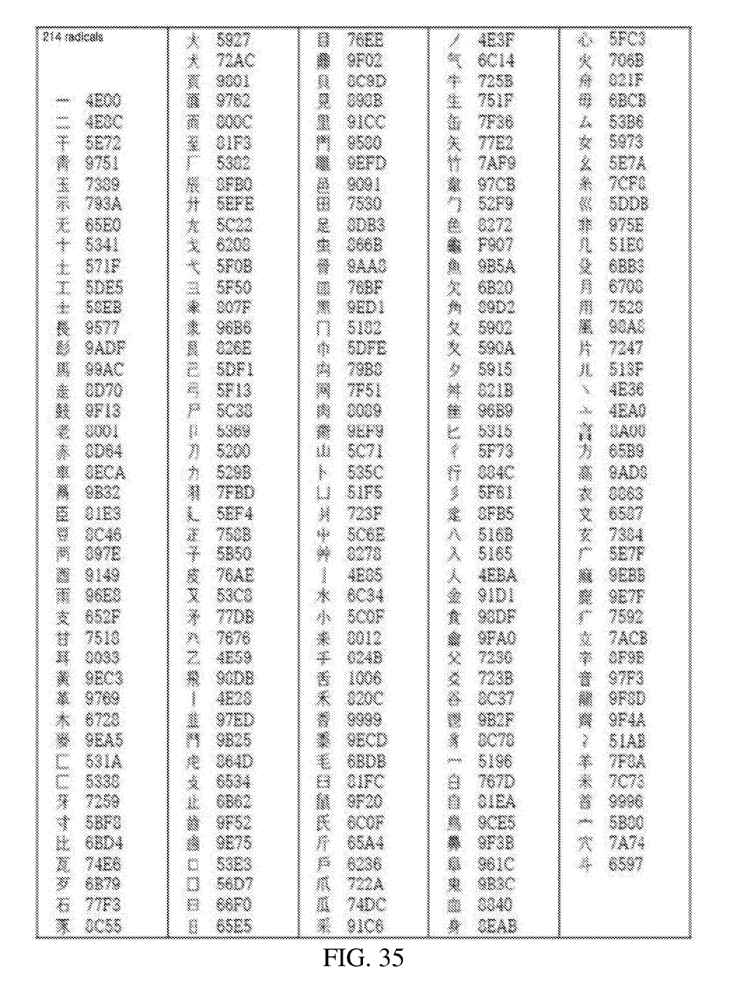

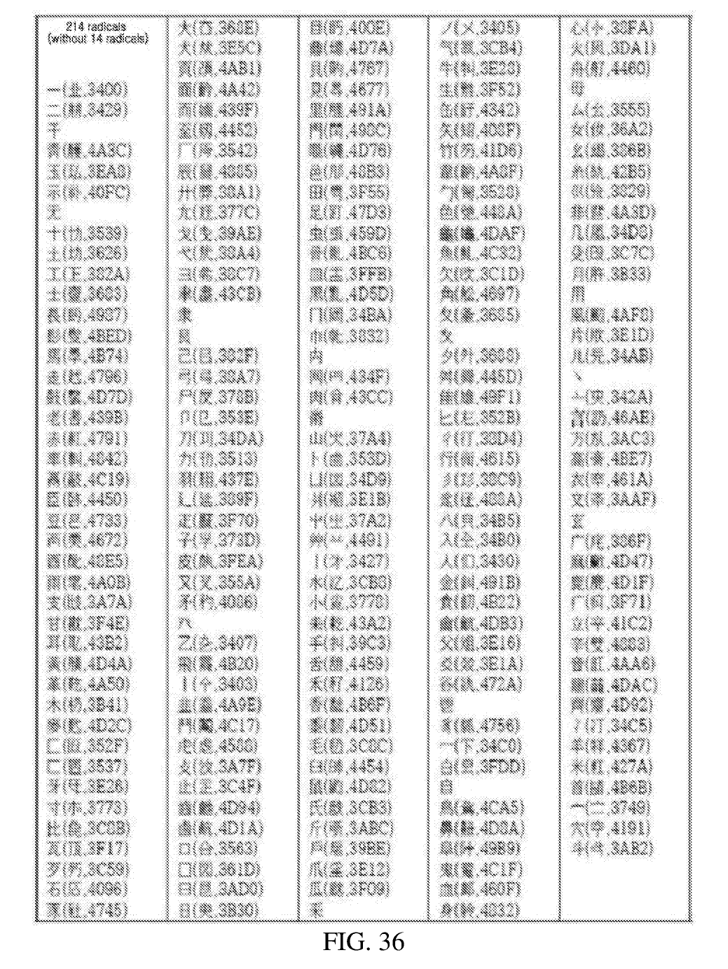

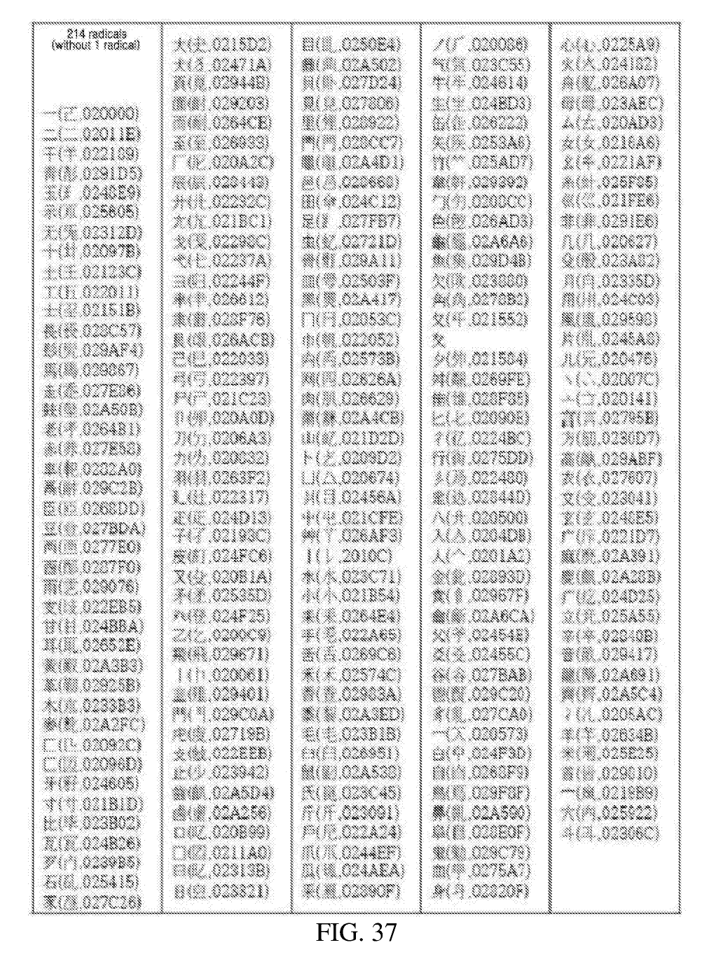

In addition, with the conventional radical table, radicals cannot be used as in the case of the English dictionary, and it takes some time to count the total strokes according to a radical. On the other hand, with radical tables of FIGS. 31 to 37 arranged according to the “ [symbol] ” character system, the search operation may be intuitively performed. Just as the English dictionary allows users to intuitively search for words in any dictionary regardless of the number of entries, the “ [symbol] ” character system makes the search operation as fast as the search operation in the English dictionary because Chinese characters are searched for in units of graphemes. Even if Chinese characters increase limitlessly, time taken to search for a character does not increase.

The best feature of the “ [symbol] ” character system is that any number of Chinese characters can be searched in units of graphemes even if the user does not know any conventional search method.

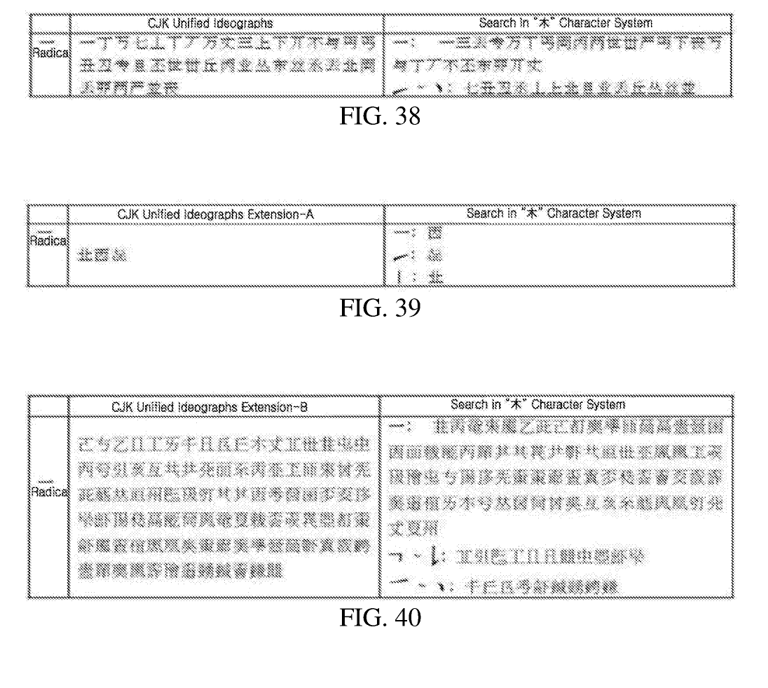

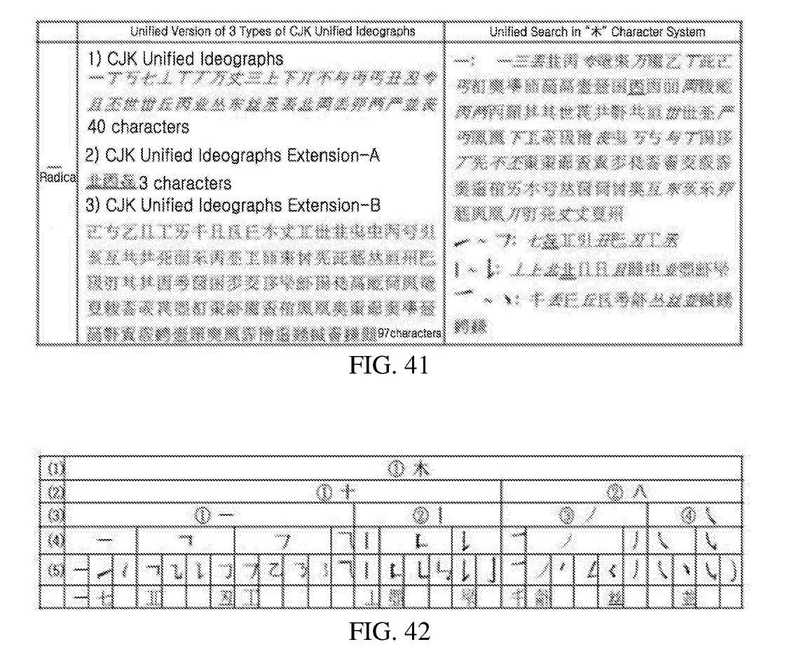

For example, “ [symbol] ([i1], one)” radicals replacing the three parts of CJK Unified Ideographs may be arranged as shown in FIGS. 38, 39 and 40, and the three parts of the CJK Unified Ideographs may be unified and summarized as shown in FIG. 41.

The “ [symbol] ” radicals unifying the three parts of the CJK Unified Ideographs may be arranged in the pyramid structure of FIG. 42 according to the “ [symbol] ” character system.

The radical list covering all Chinese characters including radicals, Radicals Supplement, and the respective types of CJK Unified Ideographs may be arranged in the pyramid structure to search for and input Chinese characters.

### EMBODIMENT 2

Hereinafter, comparison between a pinyin input method for a conventional cellular phone (e.g., iPhone 5) and the “ [symbol] ” pinyin input method of the present invention will be discussed to describe application of the “ [symbol] ” character system to a method of inputting pronunciation. The pinyin list of the simplified Chinese characters appearing on the conventional cellular phone has the following 103 characters:

r [symbol] n: [symbol] , r\check{a}n:

[symbol]

rāng: [symbol] , ráng: [symbol] , r\check{a}ng: [symbol] , r [symbol] ng:

[symbol]

ráo: [symbol] , r\check{a}o: [symbol] , r [symbol] :

[symbol]

r\check{e}: [symbol] , r [symbol] :

[symbol]

r [symbol] n: [symbol] , r\check{e}n: [symbol] , rèn:

[symbol]

[symbol]

rēng: [symbol] , réng:

[symbol]

r [symbol] :

[symbol]

r [symbol] ng: [symbol] [symbol] , r\check{o}ng:

[symbol]

r [symbol] u: [symbol] , r [symbol] u:

[symbol]

r [symbol] : [symbol] [symbol] , r\check{u}: [symbol] , r [symbol] :

[symbol]

ru\check{a}n:

[symbol]

ru [symbol] : [symbol] , ru\check{i}: [symbol] , ruì:

[symbol]

r [symbol] n:

[symbol]

ru [symbol] :

[symbol]

According to the “ [symbol] ” character system, the 103 characters are arranged as: “ [symbol] ,” “ [symbol] ,” “ [symbol] ,” “ [symbol] ,” “ [symbol] ” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] , ” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] , ” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” “ [symbol] ,” and “ [symbol] ,”.

On the screen, four rows each having 7 characters are configured, and 8 direction keys 180 of \textcircled{1} to \textcircled{8} are configured on the left and right sides of the rows. The number of direction keys is not fixed to 8. 100 or more direction keys may be configured for a large screen. Accordingly, configuration of the direction keys 180 may vary with screen size. The direction keys 180 are intended to display Chinese characters which are not displayed as there are an excessively large number of Chinese characters to be displayed. That is, if not all Chinese characters can be displayed simultaneously due to the limited size of the display unit 150, only some of the Chinese characters are displayed, and the remaining Chinese characters are displayed when inputs are provided through the direction keys 180.

\textcircled{1} [symbol] \textcircled{2}

\textcircled{3} [symbol] \textcircled{4}

\textcircled{5} [symbol] \textcircled{6}

\textcircled{7} [symbol] \textcircled{8}

As the list changes in the unit of 28 characters, “\textcircled{1},” “\textcircled{2},” and “\textcircled{3}” are replaced by “ [symbol] ,” “ [symbol] ,”and “ [symbol] ,” respectively. The Chinese characters in a list may be displayed using various methods. For example, the characters in the list may be displayed in black color, while an arrow is marked under the first Chinese character which is the representative character of the list, or the first Chinese character is underlined or displayed in a circle or square. In addition, the Chinese characters may be distinguished by color.

### EMBODIMENT 3

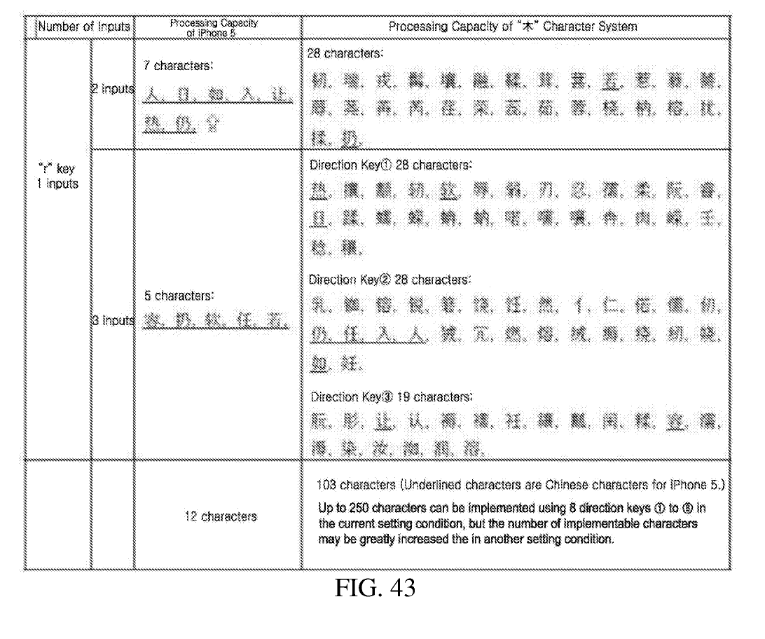

For the conventional cellular phone as shown in FIG. 43, when the user selects and inputs “r” pronunciation according to the pinyin method for simplified Chinese characters, the next 12 characters appear. To input and implement the 12 characters, 2 inputs or 3 inputs are needed.

According to the “ [symbol] ” pinyin input method, when “r” is input, 28 characters are displayed. Then, a Chinese character is input by touching the Chinese character. Accordingly, two inputs are taken to input the Chinese character. To search for a Chinese character from among the 29^{th} Chinese character and following Chinese characters, the direction keys are used, thus thee inputs are needed to input the intended Chinese character. With the “ [symbol] ” pinyin input method, 252 or fewer characters can be input through 3 or fewer inputs. With the conventional cellular phone, on the other hand, it is not possible to process 103 characters through 3 or fewer inputs.

### EMBODIMENT 4

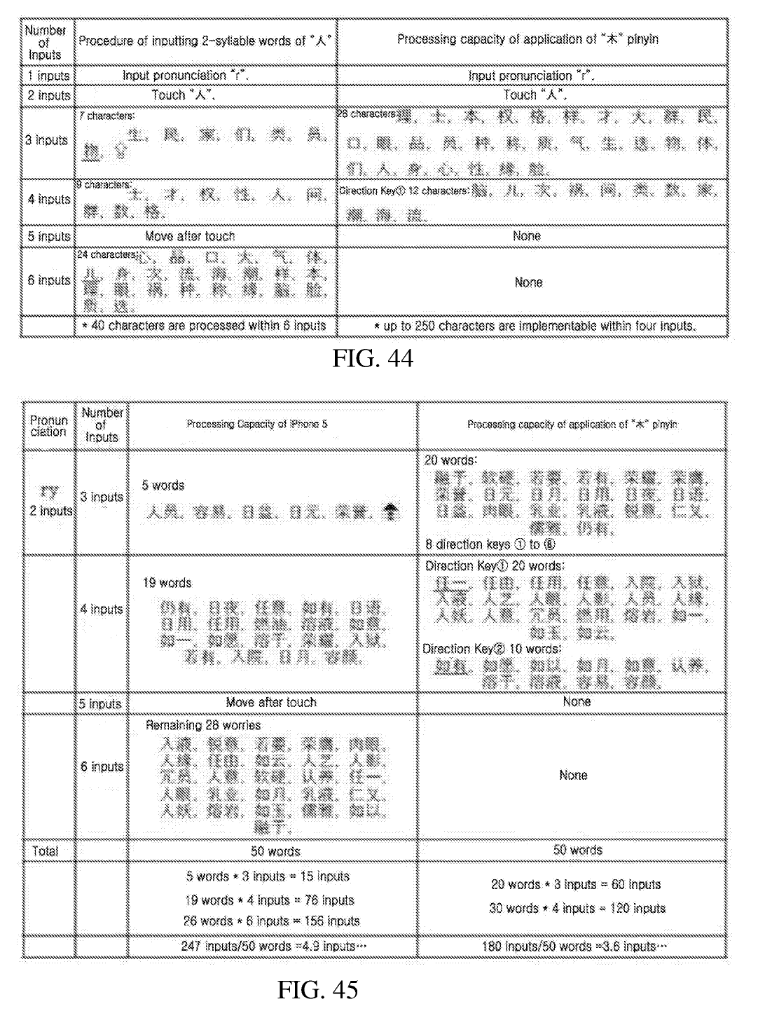

FIG. 44 illustrates a case where a Chinese character “ [symbol] ,” which has the greatest capability for creation of characters, is input, and then one syllable is combined therewith. Compared to the conventional cellular phone employing arrangement in order of frequency and one direction key 180, the “ [symbol] ” pinyin input method uses multiple direction keys according to arrangement in the “ [symbol] ” character system, and is thus absolutely advantageous over the conventional method in terms of input efficiency.

### EMBODIMENT 5

FIG. 45 illustrates input and comparison of words, which is most widely used for conventional cellular phones. When two-syllable words, which may increase in their number depending on the screen sizes of various devices such as a smartphone and a tablet PC, are applied to a screen having a size similar to that of a conventional cellular phone such that 4 rows each having 5 two-syllable words are arranged, 20 words may be processed. If “ry” is input through two inputs and then a two-syllable word is selected, the two-syllable word is input through the third input. If a two-syllable word to be input is not among the 20 words, the direction key is pressed and then the two-syllable word is selected and input through the fourth input.

\textcircled{1}“ [symbol] ,” “ [symbol] ,” “ [symbol] ,” “ [symbol] ,” “ [symbol] ”\textcircled{2}

\textcircled{3}“ [symbol] ,” “ [symbol] ,” “ [symbol] ,” “ [symbol] ,” “ [symbol] ” \textcircled{4}

\textcircled{5}“ [symbol] ,” “ [symbol] ,” “ [symbol] ,” “ [symbol] ,” “ [symbol] ” \textcircled{6}

\textcircled{7}“ [symbol] ,” “ [symbol] ,” “ [symbol] ,” “ [symbol] ,” “ [symbol] ” \textcircled{8}

According to the list of the 103 Chinese characters, the direction key “\textcircled{1}” is replaced by a first word “ [symbol] ” and the direction key “\textcircled{2}” is replaced by a first word “ [symbol] .” Although “ [symbol] ” and “ [symbol] ” serve as direction keys, inputting the same may be performed through touch. The direction keys for Chinese characters may be distinguished by a color or style.

According to the table illustrated above, when arrangement of 20 words and 8 direction keys is configured according to the “ [symbol] ” character system, up to 180 words may be input through 4 or fewer inputs, and therefore the input operation may be completed in a very short time. That is, to input up to 180 words, 60 inputs are taken for 20 words (20 words×3 inputs=60 inputs), and 640 inputs are taken for 160 words (160 words×4 inputs=640 inputs). Accordingly, an average of 3.9 inputs (700 inputs/180 words) is required to input a word. For the conventional cellular phone, the maximum number of words that can be displayed is limited to 50, and as the number of words increases, the average number of inputs increases significantly. It may be possible to greatly increase the number of words for the conventional cellular phone, but this will make it difficult to perform intuitive search due to arrangement in order of frequency. Accordingly, the word list is inevitably limited in the case of the conventional cellular phone. With the “ [symbol] ” character system, the number of words can be flexibly increased depending on conditions such as the implementation method, arrangement of words, configuration of direction keys, and the like. Accordingly, with the “ [symbol] ” character system in contrast with the conventional cellular phone, the average inputs rarely change even if the number of words changes. This enables intuitive search in any list of characters.

Chinese characters, which are ideograms, originally does not have the “grapheme” concept, and thus using a character system similar to the phonogram system to search for and input Chinese characters has been recognized as incomplete. The present invention focuses on development of a character system for searching for and inputting Chinese characters, and thus preferably attempts to address problems common to the conventional art technologies in a comprehensive manner. China, Taiwan, Japan and Korea employ alphabet, Bopomofo, Kana characters, and Hangul, respectively as auxiliary means for searching for and inputting Chinese characters. These auxiliary means use pronunciation in common.

### EMBODIMENT 6

Hereinafter, a description will be given of application of the “ [symbol] ” character system to search by total strokes. The traditional method of search by total strokes includes 1) counting the total number of strokes of an intended Chinese character, 2) searching a total stroke list, and 3) moving to the confirmed page. Chinese characters of Unicode CJK Unified Ideographs, which are arranged according to radicals, come in the range between “ [symbol] (4E00),” which has one stroke and “ [symbol] (02A6A5),” which has 64 strokes, in terms of total strokes. Since there is no historical standard for search of the Chinese character list after counting of the total strokes, it is difficult to perform the search operation in all Chinese character dictionaries and Chinese dictionaries. If searches by total strokes for all historical documents are unified according to the “ [symbol] ” character system, the search operation after counting of the total strokes will be facilitated.

An evolved search-by-total strokes method introduced by improving two operation steps uses five strokes (“ [symbol] ,” “ [symbol] ,” “ [symbol] ,” “ [symbol] ,” and “ [symbol] ”) as auxiliary means for total strokes. To search a total stroke list for hundreds of thousands of Chinese characters in, for example, the unabridged Chinese dictionary, 25 units (=5 strokes 5 strokes) need to be used. With the “ [symbol] ” character system, on the other hand, a desired Chinese character may be independently and intuitively searched for.

### EMBODIMENT 7

In the stroke input method, the five strokes (“ [symbol] ,” “ [symbol] ,” “ [symbol] ,” “ [symbol] ,” and “ [symbol] ”) used as auxiliary means for the evolved search-by-total strokes method are used. When “ [symbol] ” is input in the conventional cellular phone, sequential arrangement of the strokes “ [symbol] ,” “ [symbol] ” “ [symbol] ,” “ [symbol] ,” and “ [symbol] ” yields “ [symbol] ” In the “ [symbol] ” character system, arrangement in order of frequency used in the conventional stroke input method is not used due to inefficiency thereof. If Chinese characters in the conventional cellular phone are arranged according to the “ [symbol] ” character system, input efficiency may be enhanced since “ [symbol] ” is yielded, and intuitive search is possible even if 50 or more characters are loaded according to the screen size of the smartphone.

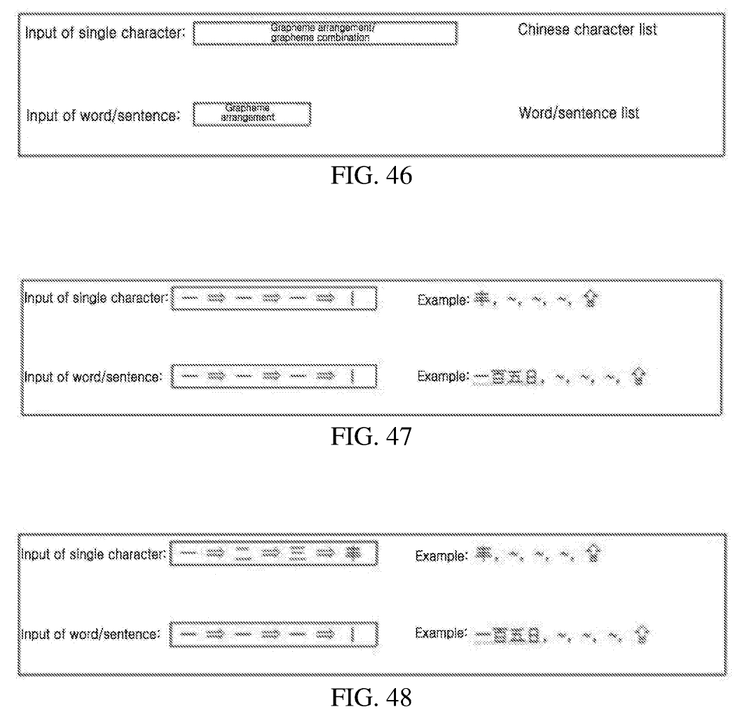

All Chinese characters can be input through arrangement and combination of single characters. Preferably, the number of arranged graphemes depends on the IT devices. If arrangements and combinations are utilized in a display window as shown in FIG. 46 in inputting Chinese characters to work on a document or write a text message, words and sentences may be quickly input. In inputting words and sentences, only single graphemes are allowed to be arranged one by one. Input of a single character and input of words and sentences may be simultaneously implemented in one screen window. For example, both a single character “ [symbol] ” and a word “ [symbol] ” may be displayed and input in an arrangement manner, as shown in FIG. 47. Alternatively, the single character “ [symbol] ” may be displayed and input in a combinatorial manner, and the word “ [symbol] ” may be displayed and input in an arrangement manner, as shown in FIG. 48. For combinatorial input of a Chinese character as exemplarily described in the Background Art, all Chinese characters may be input in a combinatorial manner like “ [symbol] [s]” [symbol] “ [symbol] [so]” [symbol] “ [symbol] [song]” in the Hangul system. If the user directly inputs a Chinese character in a combinatorial manner, the phenomenon of gradually forgetting to write the Chinese character due to use of pinyin, namely Chinese character amnesia may be prevented.

### EMBODIMENT 8

Input by writing is a method for inputting an intended Chinese character by hand- writing the Chinese character and finding the Chinese character in a Chinese character list. For example, arrangement of 10 characters “ [symbol] [symbol] ” does not bear any regularity. However, with the “ [symbol] ” character system, these characters may be logically arranged, and hundreds of Chinese characters may be loaded on a large screen of a PC. Further, even a list of thousands of Chinese characters may be accurately searched and input as in case of the English dictionary. With the conventional method of input by writing, however, the input operation may become difficult as the search operation becomes difficult with increase in the number of Chinese characters.

### EMBODIMENT 9

With the “ [symbol] ” character system, all Chinese characters may be searched for and input simply through switching between screen windows without assistance of the keyboard. Means for touch may include a mouse, a finger, laser, a stylus pen, thoughts, and movement of pupils. Although the exemplary Chinese characters are limited to simplified Chinese characters in this embodiment, it should be noted that the same principle may be applied to any Chinese characters including traditional Chinese characters, variant characters, abbreviations, simplified Chinese characters.

The display screen window is applicable to all devices including a monitor and screen that may be used to visually implement the screen window. If the screen window is visually implemented in the air, a tool such as a laser may be used to perform the search and input operations.

If representative shortcut Chinese characters followed by tens to hundreds of characters are arranged for the graphemes of the “ [symbol] ” character system depending on the screen, an intended character may be directly found. Thereby, the search and input operations may be efficiently performed. This is because the “ [symbol] ” character system is conceptually identical to the English alphabet system.

1. A device for inputting Chinese characters to an information technology terminal, comprising:
a character key comprising a plurality of keys assigned graphemes configured as consecutive variants from basic graphemes configured by strokes “ [symbol] ,” “ [symbol] ,” “ [symbol] ” and “ [symbol] ” in a stroke order system based on a “ [symbol] ” character system, the character key being configured to input the graphemes in a time series through one or more manipulations of the keys;
a selection key configured to select one from among graphemes or Chinese characters configurable through manipulation of the character key;
a storage unit configured to store the graphemes, characters and Chinese characters, the characters and Chinese characters being formed by combining, in a predetermined order, at least two graphemes selected from among the graphemes;
a controller configured to perform a control operation to generate a characters and Chinese character formed by combining the at least two graphemes selected from among the graphemes, a Chinese character selected through the selection key, and a Chinese character input through the character key by searching the storage unit for the same; and
a display unit configured to display the grapheme input through the character key, the character or Chinese character selected through the selection key, and the grapheme, character and Chinese character generated by the controller.

2. The device according to claim 1, wherein the graphemes comprise 28 graphemes divided into a first grapheme group represented by “ [symbol] ” among the basic graphemes and comprising “ [symbol] ,” “ [symbol] ,” “ [symbol] ,” “ [symbol] , ” “ [symbol] ,” “ [symbol] ,” “ [symbol] ,” “ [symbol] ,” “ [symbol] ,” “ [symbol] ,” “ [symbol] ,” and “ [symbol] ” having strokes starting to be written in the same direction, a second grapheme group represented by “ [symbol] ” and comprising “ [symbol] ,” “ [symbol] ,” “ [symbol] ,” “ [symbol] ,” “ [symbol] ,” and “ [symbol] ” having strokes starting to be written in the same direction, a third grapheme group represented by “ [symbol] ” and comprising “ [symbol] ” “ [symbol] ,”“ [symbol] ,” “ [symbol] ,” “ [symbol] ,” and “ [symbol] ” having strokes starting to be written in the same direction, and a fourth grapheme group represented by “ [symbol] ” and including “ [symbol] ,” “ [symbol] ,” “ [symbol] ,” and “ [symbol] ” having strokes starting to be written in the same direction,
wherein the 28 graphemes divided into the first to fourth grapheme groups are allocated to the keys of the character key, respectively.

3. The device according to claim 2, wherein, among the grapheme groups represented by the basic graphemes “ [symbol] ,” “ [symbol] ,” “ [symbol] ,” and “ [symbol] ,” the first grapheme group is extended to include a first extended grapheme group having “ [symbol] ,” “ [symbol] ,” “ [symbol] ,” “ [symbol] ,” “ [symbol] ,” and “ [symbol] ,” the second grapheme group is extended to include a second extended grapheme group having “ [symbol] ,” “ [symbol] ,” “ [symbol] ,” “ [symbol] ,” and “ [symbol] ,” the third grapheme group is extended to include a third extended grapheme group having “ [symbol] ,” “ [symbol] ,” “ [symbol] ,” and “ [symbol] ,” and the fourth grapheme group is extended to include a fourth extended grapheme group having “ [symbol] ,” “ [symbol] ,” and “ [symbol] ,”
wherein the graphemes of the first to fourth extended grapheme groups are allocated to the keys of the character key, respectively, such that each of the graphemes of the extended grapheme groups are input through a plurality of manipulations of the key.

4. The device according to claim 2, wherein all the graphemes including the basic graphemes and the graphemes of the first to fourth extended grapheme groups are distinguished from each other by principles of slant, length, stroke addition and protrusion of the basic graphemes “ [symbol] ,” “ [symbol] ,” “ [symbol] ,” and “ [symbol] ,” and are input in order of manipulations of the keys assigned therewith.

5. The device according to claim 1, wherein the device further comprises at least one direction key,
wherein, when all Chinese characters cannot be displayed on the display unit, the controller performs a control operation to display hidden Chinese characters according to an input of the direction key.

6. The device according to claim 5, wherein the direction key is allocated to a Chinese character displayed on the display unit.

7. The device according to claim 6, wherein the Chinese characters displayed according to the input through the direction key comprises a plurality of Chinese characters having the Chinese character allocated to the direction key as a first Chinese character.

8. The device according to claim 1, wherein at least one of the Chinese characters displayed on the display unit is assigned a shortcut key,
wherein, when the shortcut key is selected, a plurality of Chinese characters starting with the Chinese character corresponding to the shortcut key is displayed on the display unit, and the controller performs a control operation to generate a Chinese character selected through the selection key among the plurality of displayed Chinese characters.

9. The device according to claim 8, wherein the Chinese character assigned the shortcut key is displayed so as to be distinguished from the other displayed Chinese characters.

10. The device according to claim 1, wherein, when a plurality of graphemes is sequentially input through the character key, the display unit displays a combinatorial character corresponding to a combination of the graphemes in each input step of the graphemes.

11. A method for inputting Chinese characters to an information technology (IT) terminal, the method comprising:
providing the device for inputting Chinese characters according to any one of claims 1 to 10 and sequentially inputting graphemes of an intended Chinese character in stroke order of the Chinese character using the character key;
displaying, on the display unit, a character formed by combining input graphemes of the graphemes every time a grapheme of the graphemes is sequentially input through manipulation of the character key;
displaying, on the display unit, one or more Chinese characters including a character formed by combining the graphemes in a predetermined order;
selecting the intended Chinese character from the displayed Chinese characters; and
generating the selected Chinese character and inputting the same to the IT terminal.

12. The method according to claim 11, wherein the displaying of the character formed by combining the input graphemes comprises:
every time a grapheme of the Chinese character to be input are input in stroke order thereof, displaying, on the display unit, a new character formed by combining the grapheme with previously input graphemes of the Chinese character.

13. The method according to claim 11, further comprising:
allocating a shortcut key to a specific Chinese character of the one or more Chinese characters displayed on the display unit;
selecting the allocated shortcut key in inputting Chinese character; and
displaying, on the display unit, at least one Chinese character started with the specific Chinese character corresponding to the selected shortcut key,
wherein the allocating of the shortcut key, the selecting of the allocated shortcut key and the displaying of the at least one Chinese character are performed after the displaying of the one or more Chinese characters.

14. The method according to claim 11, wherein, when all the Chinese characters cannot be displayed on the display unit, hidden Chinese characters are additionally displayed according to an input of the direction key.

15. A method for searching for Chinese characters using a device for inputting Chinese characters to an information technology (IT) terminal, the method comprising:
providing the device according to any one of claims 1 to 10 and a search key;
sequentially inputting graphemes of an intended Chinese character in stroke order of the Chinese character using the character key;
displaying, on the display unit, a character formed by combining input graphemes of the graphemes every time a grapheme of the graphemes is sequentially input through manipulation of the character key;
displaying, on the display unit, one or more Chinese characters including a character formed by combining the graphemes in a predetermined order;
selecting the intended Chinese character from the displayed Chinese characters; and
searching for detailed information about the selected Chinese character stored in the storage unit according to an input of the search key and displaying the same on the display unit.

16. The method according to claim 15, wherein the displaying of the one or more Chinese characters comprises:
inputting the direction key when not all the Chinese characters including the character formed by combining the graphemes can be displayed on the display unit; and
displaying hidden Chinese characters according to the input of the direction key.

17. The method according to claim 16, wherein the Chinese characters displayed according to the input of the direction key comprise a plurality of Chinese characters starting with a Chinese character allocated to the direction key.

18. The method according to claim 15, wherein a shortcut key is set to a specific Chinese character among the Chinese characters displayed on the display unit,
wherein, when the shortcut key is selected, one or more Chinese characters starting with the Chinese character corresponding to the shortcut key are displayed on the display unit.

19. The device according to claim 3, wherein all the graphemes including the basic graphemes and the graphemes of the first to fourth extended grapheme groups are distinguished from each other by principles of slant, length, stroke addition and protrusion of the basic graphemes “ [symbol] ,” “ [symbol] ,” “ [symbol] ,” and “ [symbol] ,” and are input in order of manipulations of the keys assigned therewith.

20. The method according to claim 13, wherein, when all the Chinese characters cannot be displayed on the display unit, hidden Chinese characters are additionally displayed according to an input of the direction key.
